(19) United States
(12) Patent Application Publication
(10) Pub. No.: US 2024/0111679 A1
(43) Pub. Date: Apr. 4, 2024

(54) HARDWARE PROCESSOR HAVING MULTIPLE MEMORY PREFETCHERS AND MULTIPLE PREFETCH FILTERS

(71) Applicant: Intel Corporation, Santa Clara, CA (US)

(72) Inventors: Seth Pugsley, Hillsboro, OR (US); Mark Dechene, Hillsboro, OR (US); Ryan Carlson, Hillsboro, OR (US); Manjunath Shevgoor, Beaverton, OR (US)

(73) Assignee: Intel Corporation, Santa Clara, CA (US)

(21) Appl. No.: 17/958,334

(22) Filed: Oct. 1, 2022

(51) Int. Cl. G06F 12/0862; G06F 9/345; G06F 12/0882

(52) U.S. Cl. CPC G06F 12/0862; G06F 9/3455; G06F 12/0882

(57) ABSTRACT

Techniques for prefetching by a hardware processor are described. In certain examples, a hardware processor includes execution circuitry, cache memories, and prefetcher circuitry. The execution circuitry is to execute instructions to access data at a memory address. The cache memories include a first cache memory at a first cache level and a second cache memory at a second cache level. The prefetcher circuitry is to prefetch the data from a system memory to at least one of the plurality of cache memories, and it includes a first-level prefetcher to prefetch the data to the first cache memory, a second-level prefetcher to prefetch the data to the second cache memory, and a plurality of prefetch filters. One of the prefetch filters is to filter exclusively for the first-level prefetcher. Another of the prefetch filters is to maintain a history of demand and prefetch accesses to pages in the system memory and to use the history to provide training information to the second-level prefetcher.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, exception handling, and external input and output (IO). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 illustrates a block diagram of a hardware processor (e.g., core) comprising a set of clusters of execution circuits coupled to memory circuitry that includes a level (e.g., L1) of memory circuitry that is sliced according to address values according to examples of the disclosure.

FIG. 2 illustrates a more detailed block diagram of an execution cluster coupled to a cluster of a level (e.g., L0) of memory circuitry according to examples of the disclosure.

FIG. 3 illustrates a more detailed block diagram of the level (e.g., L1) of memory circuitry that is sliced according to address values according to examples of the disclosure.

FIG. 4 illustrates a more detailed block diagram of prefetcher circuitry according to examples of the disclosure.

FIG. 5 is a flow diagram illustrating operations of a method for prefetching by a hardware processor according to examples of the disclosure.

FIG. 6 illustrates an example computing system.

FIG. 7 illustrates a block diagram of an example processor and/or System on a Chip (SoC) that may have one or more cores and an integrated memory controller.

FIG. 8A is a block diagram illustrating both an example in-order pipeline and an example register renaming, out-of-order issue/execution pipeline according to examples.

FIG. 8B is a block diagram illustrating both an example in-order architecture core and an example register renaming, out-of-order issue/execution architecture core to be included in a processor according to examples.

FIG. 9 illustrates examples of execution unit(s) circuitry.

FIG. 10 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for managing a memory of a hardware processor core.

In the following description, numerous specific details are set forth. However, it is understood that examples of the disclosure may be practiced without these specific details. In other instances, well-known circuits, structures, and techniques have not been shown in detail in order not to obscure the understanding of this description.

References in the specification to “one example,” “an example,” “examples,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to effect such feature, structure, or characteristic in connection with other examples whether or not explicitly described.

A (e.g., hardware) processor (e.g., having one or more cores) may execute instructions (e.g., a thread of instructions) to operate on data, for example, to perform arithmetic, logic, or other functions. For example, software may request an operation and a hardware processor (e.g., a core or cores thereof) may perform the operation in response to the request. Certain operations include accessing one or more memory locations, e.g., to store and/or read (e.g., load) data. A system may include a plurality of cores, e.g., with a proper subset of cores in each socket of a plurality of sockets, e.g., of a system-on-a-chip (SoC). Each core (e.g., each processor or each socket) may access data storage (e.g., a memory). Memory may include volatile memory (e.g., dynamic random-access memory (DRAM)) or (e.g., byte-addressable) persistent (e.g., non-volatile) memory (e.g., non-volatile RAM) (e.g., separate from any system storage, such as, but not limited, separate from a hard disk drive). One example of persistent memory is a dual in-line memory module (DIMM) (e.g., a non-volatile DIMM), for example, accessible according to a Peripheral Component Interconnect Express (PCIe) standard.

In certain examples, a hardware processor core includes memory circuitry (e.g., as an “execution circuitry” of the core). In certain examples, the memory circuitry processes memory requests and page translation requests from front end circuitry (e.g., including fetch circuitry for fetching instructions from memory, decoder circuitry for decoding instructions, and delivering them to scheduling/execution circuitry). In certain examples, memory circuitry processes load operations (e.g., load micro-operations (μops)) and store operations (e.g., store micro-operations (μops)), returning the results, and/or final status (e.g., complete or incomplete (e.g., fault)) to the out-of-order (OOO) circuitry for subsequent instructions and/or instruction retire. In certain examples, memory circuitry receives off core (e.g., uncore) snoops and ensures that correct coherence actions are taken in the core. In certain examples, memory circuitry is sub-divided into multiple sections (e.g., parcels). In certain examples, memory circuitry is sub-divided into five distinct sections (e.g., parcels): L0 memory circuitry (e.g., zeroth level), L1 memory circuitry (e.g., first level), L2 memory circuitry (e.g., second level), page miss handler (PMH) circuitry, and prefetcher circuitry.

Data may be stored in a processor's cache (e.g., of any level, such as, but not limited to, L3, L2, L1, etc.), system memory (e.g., separate from a processor), or combinations thereof. In certain examples, memory is shared by multiple cores. In certain examples, a cache line is a section (e.g., a sector) of memory (e.g., a cache) that is managed as a unit for coherence purposes. In certain examples, a cache line is referenced by an (e.g., virtual) address, e.g., a program address that the memory maps to a physical address. A virtual address may be a linear address. Mapping may occur during a process referred to as translation. In certain examples, a linear address is formed by adding (e.g., concatenating) a segment address (e.g., referred to by a segment selector) to the virtual address (e.g., virtual offset).

To effectively manage complexity, in certain examples the memory circuitry (e.g., cache) is divided internally into clusters (e.g., via strands) in some sections (e.g., places), and into slices in other sections (e.g., places).

In certain examples, clusters divide the instruction stream into (e.g., medium-sized) groups of contiguous instructions called strands, and then one or more strands may be executing on a cluster at a time. In certain examples, clusters are most effective when executing work that is adjacent in program order to other work. In certain examples, the memory circuitry in (e.g., only) the L0 memory circuitry (e.g., zeroth level) is clustered.

In certain examples, slices divide the memory instruction stream based upon the (e.g., linear) addresses the instructions access. In certain examples, slices create an inherent proof that certain memory instructions can mostly ignore other instructions, and therefore reduce ordering and correctness checks, when different memory instructions have been assigned to different slices. In certain examples, slices are most effective when the memory address pattern is relatively balanced across cache lines. In certain examples, the memory circuitry in (e.g., only) the L1 memory circuitry (e.g., first level) and/or the L2 memory circuitry (e.g., second level) memory circuitry (e.g., zeroth level) are both sliced.

In certain examples, to transition between the cluster domain and the slice domain, memory operations traverse a crossbar (e.g., a crossbar switch).

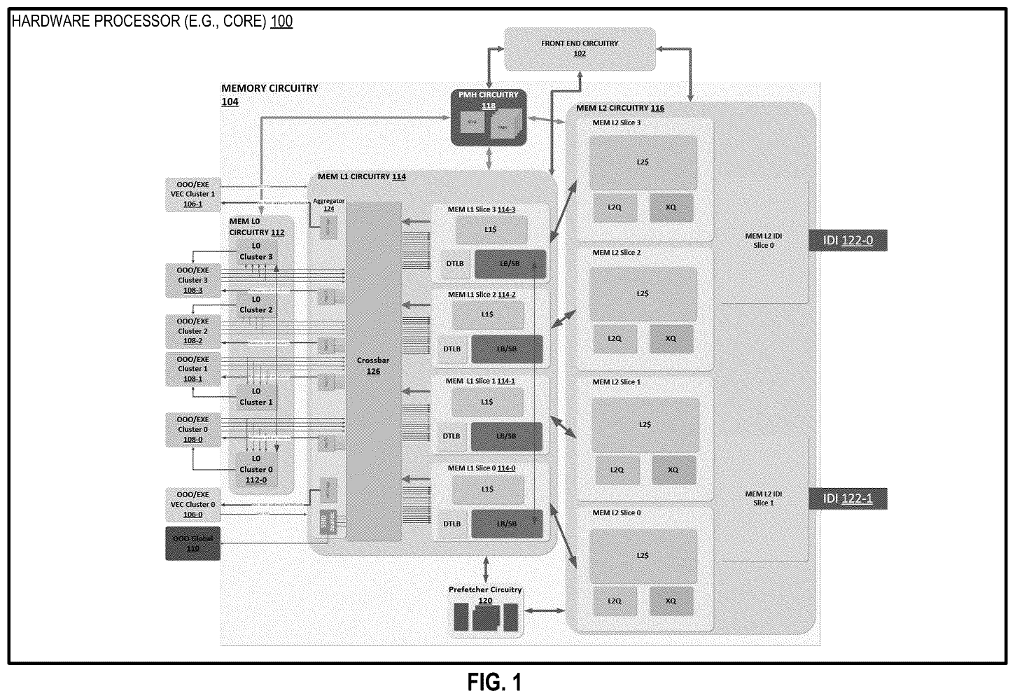

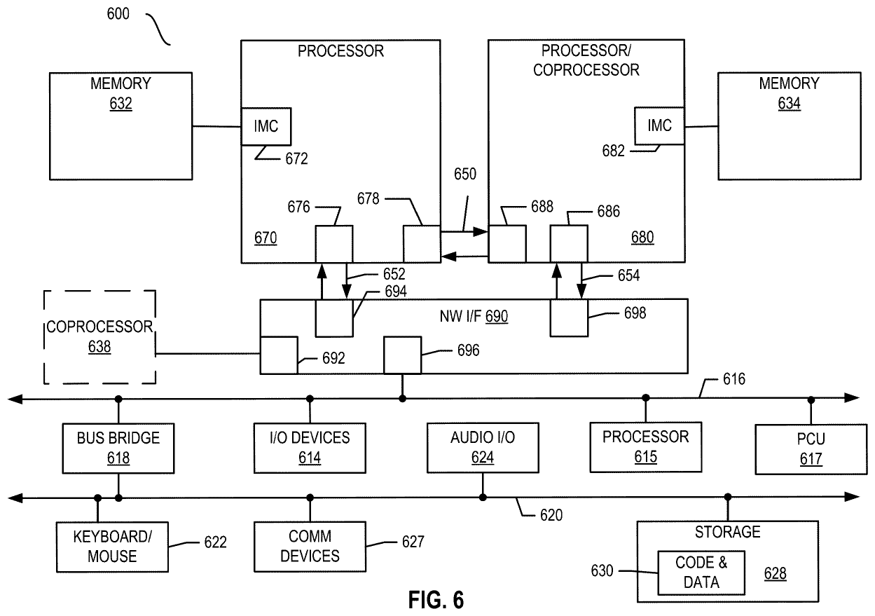

FIG. 1 illustrates a block diagram of a hardware processor (e.g., core) 100 comprising a set of clusters of execution circuits coupled to memory circuitry that includes a level (e.g., L1) of memory circuitry that is sliced according to address values according to examples of the disclosure. In certain examples, processor core 100 is a core of a system disclosed herein, e.g., in FIGS. 6 through 9. In certain examples, processor core 100 couples to a system memory, e.g., memory 632 in FIG. 6.

Depicted processor (e.g., core) 100 includes front end (FE) circuitry 102 (e.g., including fetch circuitry for fetching instructions from memory, decoder circuitry for decoding instructions and delivering them to scheduling/execution circuitry). Depicted processor (e.g., core) 100 includes out-of-order (OOO) (e.g., out of program order) and execution clusters, e.g., a vector out-of-order (OOO) (e.g., out of program order) and execution clusters 106-0 to 106-1 (although two vectors clusters are shown, a single, none, or any plurality of vector clusters may be utilized in certain examples), and (e.g., scalar) out-of-order (OOO) (e.g., out of program order) and execution clusters 108-0, 108-1, 108-2, and 108-3 (although four scalar clusters are shown, a single, none, or any plurality of scalar clusters may be utilized in certain examples). In certain examples, the hardware processor (e.g., core) 100 includes OOO global circuitry 110, e.g., to maintain global ordering in an out-of-order superscalar processor core. In certain examples, the OOO global circuitry 110 includes circuitry to maintain global ordering in a processor core that utilizes multiple clusters to execute multiple strands.

Depicted processor (e.g., core) 100 includes memory circuitry 104, e.g., as a multiple level cache. In certain examples, the memory circuitry 104 includes a coupling to additional (e.g., system) memory, for example, in-die interface (IDI) 122-0 and/or in-die interface (IDI) 122-1.

In certain examples, the memory circuitry 104 includes five distinct sections (e.g., parcels): L0 memory circuitry (e.g., L0 MEM) 112, L1 memory circuitry (e.g., L1 MEM) 114, L2 memory circuitry (e.g., L2 MEM) 116, page miss handler (PMH) circuitry 118, and prefetcher circuitry 120.

### L0 MEM

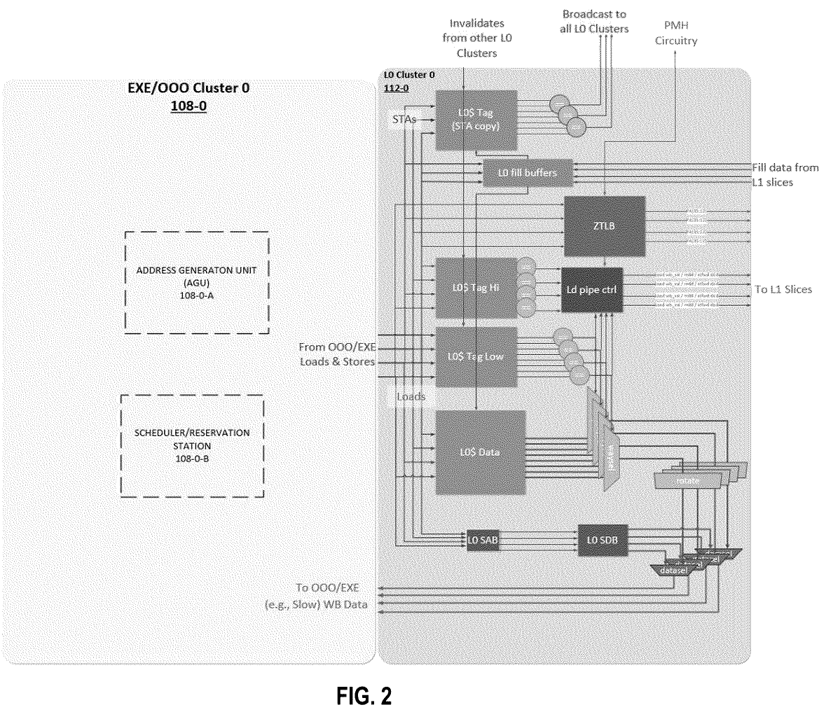

FIG. 2 illustrates a more detailed block diagram of an execution cluster 108-0 coupled to a cluster 112-0 of a level (e.g., L0) of memory circuitry according to examples of the disclosure. Depicted cluster 108-0 may include an address generation unit 108-0-A to generate addresses, e.g., for memory accesses and/or a scheduler/reservation station 108-0-B, e.g., to schedule memory access operations for servicing in memory circuitry (e.g., L0 MEM, L1 MEM, L2 MEM, etc.).

Referring to FIGS. 1 and 2, in certain examples, the L0 MEM 112 is the smallest, fastest unit of memory in memory circuitry 104 (e.g., in core 100) and attempts to service loads in a certain number of threshold (e.g., about 3) cycles. In certain examples, L0 MEM 112 attempts to satisfy a portion of loads (e.g., about 40%) that meet the most common cases. In certain examples, L0 MEM 112 has two key benefits that it provides: first, it provides a large fraction of loads with low latency, and second, it provides bandwidth resilience for the larger L1 MEM 114 that is sliced by address. In certain examples, when many loads are mapped to the same cache line (and therefore the same L1 MEM 114 slice), they would be limited by the comparatively narrow bandwidth of an L1 MEM slice—but in these cases, L0 MEM 112 will maintain a cache of the most frequently used addresses and service the hot-line loads.

In certain examples, L0 MEM 112 is divided into clusters. For example, with one cluster of L0 MEM 112 attached to one OOO cluster, e.g., cluster 112-0 of L0 MEM 112 attached to OOO cluster 108-0, etc. In certain examples, L0 MEM 112 operates in parallel with L1 MEM 114, e.g., such that L0 MEM 112 will attempt to service a load in parallel with the load being transmitted to L1 MEM 114 over the crossbar 126. In certain examples, if L0 MEM 112 is successful in completing a load, it will send an “10 complete” signal to L1 MEM 114, which will prevent loads from being dispatched in L1 or cancel them in-flight.

In certain examples, L0 MEM 112 will have a lower hit rate compared to L1 MEM 114, and thus, to avoid spurious wakeups, an L0 hit predictor may be used in OOO to determine when to generate a wakeup signal to the reservation station (RS) to schedule the dependents in L0 timing.

In certain examples, each cluster of L0 MEM 112 contains its own:
Zero-Level Cache (ZLC) (e.g., L0 cache (L0$) tag array and L0$ data array. In certain examples, the L0$ tag array may be subdivided into L0$ tag low array and L0$ tag high array to reduce access latency): Small set-associative cache that features a low access latency, e.g., where the ZLC is virtually indexed and virtually tagged.
L0 Store Address Buffer (L0SAB): Subset of the full store address buffer. In certain examples, this contains only the portion of fields of stores needed for store to load forwarding, and only the stores within the attached OOO cluster.
L0 Store Data Buffer (LOSDB): Subset of the full store data buffer. In certain examples, this contains store data only for the bottom (e.g., 64) bits of each store, and only the stores within the attached OOO cluster.
Zero-Level TLB (ZTLB): Small fully-associative TLB used to prove that a linear address maps to cacheable memory and is therefore legal for completion in L0 MEM, and provide a physical address translation. (Either from ZLC or Store-to-Load forwarding).
Zero-Level Fill Buffers (LOFB): one buffer per L1 slice.
L0 Mini-Memory Order Buffer (MOB): Small store-to-load forwarding scheduler, with a plurality of (e.g., 4) entries per load pipeline (e.g., “pipe”). In certain examples, some parts also live in OOO, but L0 MEM is responsible for entry allocation, data read, and writeback. In certain examples, the mini-MOB also has the Stale Data Watchdog (SDW) which disables mini-MOB allocation if deallocated SDB entries cause too many loads to nuke.

In certain examples, each cluster of L0 MEM 112 also includes some pieces physically located in OOO, but logically owned by MEM:
Memory Disambiguation (MD) Predictor: CEIP (e.g., compressed effective instruction pointer, a hashed effective instruction pointer)-indexed structure to predict whether a load may bypass unknown store addresses (e.g., “STAs”) without generating a clear.
L0 Load Hit Predictor (LOLHP): CEIP-indexed structure to predict whether a load will hit the L0 (either ZLC or L0SAB). In certain examples, this will wake up the load's dependents if it predicts hit.
L0 Mini-MOB: OOO is responsible for wakeup and scheduling.

In certain examples, each cluster of L0 MEM 112 has its own set of pipelines:
L0 Load Pipeline: In certain examples, this is the only load pipeline in L0 MEM. In certain examples, this is responsible for receiving load dispatch and AGU payloads, looking up the Zero Level Cache, checking the L0SAB for address overlap, and potentially forwarding data.
L0 Mini-MOB Pipeline: Handles loads that schedule out of the mini-MOB. In certain examples, this is responsible for reading data from a known store data buffer (SDB) entry and writing back.
L0 Store Address Pipeline: Pipeline to receive store address payloads, update L0SAB, and invalidate L0 cache entries and fill buffers that match store address.
L0 Store Data Pipeline: Pipeline to receive store data payloads and update LOSDB.
ZLC Fill Pipeline: Receives data from the L1 MEM and fills it into the ZLC.

TABLE 1
Example L0 MEM Parameters per L0 MEM Cluster

| Name | Size | |
|---|---|---|
| L0 MEM Clusters | 4 | clusters |
| ZLC size | 8 | KB |
| ZLC organization | 16 sets, 8 ways, | |
| | 64 bytes per line | |
| ZTLB size | 32 | entries |
| SB entries | 144 | entries |
| SB entries per strand | 36 entries | |
| | per strand | |
| FB entries | 4 | entries |

TABLE 2
Example L0 MEM Pipelines per L0 MEM Cluster

| Name | Abbreviation | Pipes | Summary |
|---|---|---|---|
| L0 Load Pipe | zld | 4 | Executes loads in L0 |
| L0 Mini-MOB | zmb | 4 | Executes loads blocked |
| Pipe | | | on STDs in L0 |
| L0 STA Pipe | zst | 3 | Receives STAs in L0, invalidates |
| | | | ZLC cache lines |
| L0 STD Pipe | zsd | 3 | Receives STDs in L0 |
| ZLC Fill Pipe | zfl | 1 | Fills ZLC with cache lines |

### L1 MEM

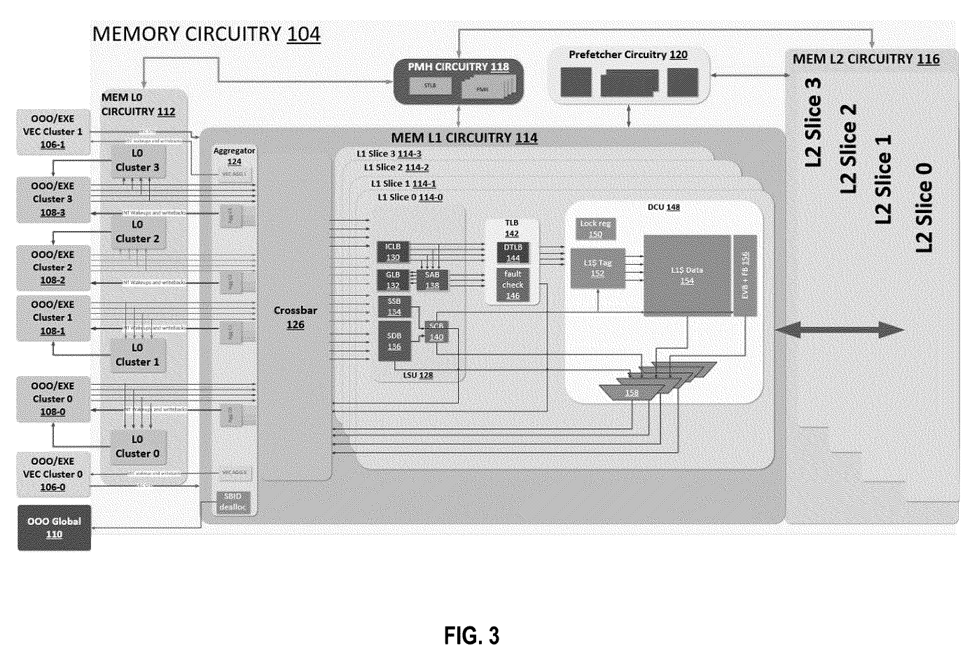

FIG. 3 illustrates a more detailed block diagram of the level (e.g., L1) 114 of memory circuitry that is sliced according to address values according to examples of the disclosure. In certain examples, a load pipeline includes the components shown in load store unit 128.

Referring to FIGS. 1 and 2, in certain examples, the L1 MEM is a L1 unit of memory in memory circuitry 104 (e.g., in core 100) with (e.g., larger than L0's) caches, (e.g., larger than L0's) buffers, and supports all loads and stores (e.g., in a moderate latency). In certain examples, the L1 MEM 114 has interfaces with the out-of-order circuitry (OOO) and the execution circuitry (EXE) (cumulatively OOO/EXE clusters, e.g., OOO/EXE 106-0, 106-1, 108-0, 108-1, 108-2, 108-3, and 110 in FIG. 1) and the front end (FE) circuitry 102. In certain examples, the OOO and EXE interfaces are used to synchronize processing around loads and stores, while the FE interface is used to detect potential self-modifying code (SMC) cases. In certain examples, loads that complete out of L1 MEM 114 will have a relatively short cycle load-to-use latency, e.g., assuming the most favorable and fastest alignments.

In order to provide scalable performance, the L1 MEM 114 is sliced by address. In certain examples, a given cache line of memory may only exist in a single slice of L1 MEM. This provides significant scope reduction of memory ordering checks. In certain examples, there are a plurality (e.g., shown as 4 slices, although other numbers of slices may be utilized) of L1 MEM 114, where each slice contains a different range of address values compared to the other slices. In certain examples, after a load or store has passed address generation (e.g., by AGU as shown in FIG. 2), the appropriate L1 slice for that memory operation is determined by looking at the (e.g., linear) address bits of the load or store. In the case of line splits, multiple L1 MEM slices may be needed to produce the final load or store result. In certain examples, a given (e.g., single) cache line of memory will only exist in a single slice of memory, e.g., and a load or a store can be split such that there is access to some byte(s) in a first cache line and then the rest of the byte(s) in the subsequent cache line (e.g., to logically form the single cache line). In certain examples, a split happens when a load or store starts too close to the end of the line (e.g., for a request for 8 bytes starting from the last byte of one cache line, which splits as one (the last) byte from the one cache line and the (first) seven bytes of the next cache line).

In certain examples, each OOO/EXE cluster can produce at most a first threshold (e.g., 4) loads or at most a second threshold (e.g., 3) stores per cycle (e.g., loads or stores within respective data cache unit in each slice, e.g., with data cache unit 148 shown for L1 slice 0 114-0), or a combination of the two up to a total of a third threshold (e.g., 4) of memory operations (e.g., μops). Ideally, the addresses of these memory operations (e.g., μops) are distributed evenly across the (e.g., 4) slices. However, in the worst scenario in one example, each slice can receive 16 aloads or 12 store addresses and 12 store data. In certain examples, the L1 mem slices guarantee they will sink all requests that they receive from OOO/EXE. In certain examples, the L1 mem slices will buffer these memory operations (e.g., μops) in the load and store buffers and in each cycle select up to the first threshold (e.g., 4) loads and the second threshold (e.g., 3) store addresses to be executed. In certain examples, L1 MEM has separate pipelines for loads and stores and each slice may write back to EXE/OOO up to the first threshold (e.g., 4) loads and the second threshold (e.g., 3) store addresses.

The MEM L1 circuitry 114 includes crossbar 126 as a set of couplings (e.g., wires) which connect all OOO/EXE clusters to all L1 MEM slices.

In certain examples, the OOO circuitry is organized into a plurality of (e.g., 4) clusters which feed memory operations (e.g., μops) to the (e.g., same number of) L1 MEM slices. However, in certain examples, the cluster is address agnostic and does not know ahead of time to which slice it should send the memory operation (e.g., μop). As such, in certain examples, the OOO (e.g., of an OOO/EXE cluster) broadcasts the memory operations (e.g., μops) (e.g., via a DispatchAGU indication) to all slices, and a certain number of cycles later the EXE (e.g., of an OOO/EXE cluster) broadcasts the address it computed. In certain examples, each slice will check the (e.g., linear) address (e.g., a proper subset of the bits, e.g., bits in bit positions [7:6]) and determine whether the memory operation (e.g., μop) belongs to the slice. In certain examples, if bit positions [7:6] of the (e.g., linear) address are 0b00 (e.g., in binary format), the memory operation will be sent to slice 0, while if bit positions [7:6] of the (e.g., linear) address are 0b11, the memory operation will be sent to slice 3.

In certain examples, the crossbar 126 of the L1 MEM circuitry 114 is responsible for transmitting load memory operations (e.g., load μops), store address memory operations (e.g., store address μops), and store data memory operations (e.g., store data μops) from OOO and EXE clusters into L1 MEM slices. In certain examples, while loads and stores have specific target slices based on their address, the information is broadcast to all slices, and each slice makes its own decisions on what data to catch and process.

In certain examples, the crossbar 126 of the L1 MEM circuitry 114 is responsible for transmitting results from L1 MEM slices back to OOO and EXE clusters. In certain examples, this is a broadcast of results back to clusters and the aggregator 124 (e.g., corresponding aggregator circuitry for each OOO/EXE cluster) make decisions on what data to collect.

In certain examples, each L1 memory slice can send responses to any OOO/EXE cluster, e.g., and the responses are sent back over the crossbar 126 to all clusters. In certain examples, one EXE/OOO cluster cannot sink (e.g., service) the combined responses from all slices, so certain MEM L1 circuitry 114 uses an L1 aggregator 124 (e.g., aggregation manager) described herein.

In certain examples, the L1 MEM aggregator 124 is a sub-component of L1 MEM 114 that deals outside of the sliced memory domain. In certain examples, there are per-cluster portions of the aggregator (e.g., to achieve per-cluster aggregation), and global portions of the aggregator. In certain examples, the L1 aggregator 124 is responsible for coordinating the L1 slices and their communication with other components, e.g., circuitry. In certain examples, this coordination can happen at a cluster level (for example, combining and reducing L1 slices' writeback responses to each OOO/EXE cluster), at a global level (e.g., OOO global 110) (for example deallocation (dealloc) of store buffers identification values (SBIDs) or memory ordering nuke (MONuke management), or internal to MEM L1 circuitry 114 for inter-slice coordination.

In certain examples, the aggregator 124 includes a clustered aggregator and/or a global aggregator. In certain examples, a clustered aggregator includes a load write back (LWB) aggregator to coordinate wakeups and writebacks from slices to the appropriate cluster and/or a store write back aggregator that coordinates writebacks from the store address operations (e.g., “STAs”) in slices to the appropriate cluster. In certain examples, the global aggregator includes a SBID deallocation aggregator (e.g., “SBID dealloc”) to coordinate deallocation of store buffers from slices back to OOO.

In certain examples, a store is split into multiple operations (e.g., μops), for example, a store address (“STA”) operation (e.g., μop) for the address of data that is to be stored and a store data (“STD”) operation (e.g., μop) for the data that is to be stored at that address.

In certain examples, each slice of L1 MEM contains its own:
Incomplete Load Buffer (ICLB) (e.g., ICLB 130 for L1 Slice 0 114-0)—Holds loads that have been executed by AGU and are logically part of this slice, but have not yet completed.
Global Load Buffer (GLB) (e.g., GLB 131 for L1 Slice 0 114-0)—Tracking for all loads in the out-of-order window. In certain examples, only entries for loads that are logically part of this slice will be filled out in detail (e.g., fully filled out) (e.g., filled out with a full physical address, store forwarding information, and memory predictor training information) and/or loads that are logically part of other slices will capture a single bit to indicate the load is out-of-slice.
Store Address Buffer (SAB) (e.g., SAB 138 for L1 Slice 0 114-0)—Tracking for the address component of all stores in the out-of-order window. In certain examples, only entries for stores that are logically part of this slice will be filled out in detail and/or stores outside of this slice will be marked as out of slice for control purposes.
Store Data Buffer (SDB) (e.g., SDB 136 for L1 Slice 0 114-0)—Data storage for all stores in the out-of-order window. In certain examples, an STD operation (e.g., μop) may not know which slice the address will reside in, so the SDB will be populated for all stores whether or not the address eventually resides within this slice. In certain examples, SDB entries are mapped 1:1 against SAB entries.
Senior Store Buffer (SSB) (e.g., SSB 134 for L1 Slice 0 114-0)—Data storage for the portion of a store that is used in the store coalescing pipeline. In certain examples, this is primarily the physical address and size of a store.
Store Coalescing Buffer (SCB) (e.g., SCB 140 for L1 Slice 0 114-0)—A cache-line aligned buffer in the logical path between a retired store and the data cache unit (DCU) and/or fill buffer (FB) that potentially combines multiple stores into a single entry.
Data-side Translation Lookaside Buffer (e.g., DTLB 144 in translation lookaside buffer TLB 142 for L1 Slice 0 114-0)—Contains linear to physical mappings to translate loads and STAs that will execute within this slice. In certain examples, the DTLB is subdivided into buffers per page size.
Data Cache Unit (DCU) (e.g., DCU 147 for L1 Slice 0 114-0)—Storage and tracking for the L1 data cache within this slice, e.g., which contains a plurality of storage (e.g., 64 KB) of cache organized as a plurality of (e.g., 128) sets, a plurality of (e.g., 8) ways, where each cache line is multiple (e.g., 64) bytes.
Fill Buffers (FB) (e.g., FB 156 for L1 Slice 0 114-0)—Structure to services DCU misses for both loads and senior stores. In certain examples, these misses will be sent as requests to additional memory, e.g., L2 MEM 116.
Global Ordering Buffer (GOB)—Structure to globally order stores in fill buffers across all slices of L1 MEM. In certain examples, there is copy of the GOB in every L1 MEM slice.
Eviction Buffers (EVB) (e.g., EVB 156 for L1 Slice 0 114-0)—Structure to hold evicted modified cache lines from the DCU and manage sending eviction requests to the L2 and respond to writepull requests from the L2. In certain examples, one entry will be reserved for snoops.
Split Registers (SR)—in certain examples, these are not physically located in the slice, but the control logic is within a slice and the registers are logically associated with the low-half slice of a split load.
Self-Modifying Code Inspection Reduction Filter (SMIRF)—Filter to prove which STA memory operations (e.g., μops) may safely skip sending an SMC snoop check to the FE and reduce the number of SMC checks that are sent.
Global Store Scheduler (GSS)—Tracks store ordering across slices and guarantees correct store ordering at dispatch on the store write pipeline

In certain examples, each slice of L1 MEM has its own set of pipelines:
Load Receipt Pipeline—Receives load dispatch and AGU payloads from OOO & EXE and writes the payload into an ICLB entry.
ICLB Scheduling Pipeline—Chooses oldest ready load on a load port from the ICLB and tries to schedule it into the load pipeline.
Load Pipeline—The main load pipeline in L1 MEM to execute a load and write back its results.
Store Address Receipt Pipeline—Receives store address operation (e.g., μop) payloads and writes them into the store address buffer.
SAB Scheduling Pipeline—Chooses oldest ready STA on a STA port from the SAB and tries to schedule it into the store address pipeline.
Store Data Pipeline—Receives store data payload and writes it into the store data buffer.
Store Address Pipeline—The main store address pipeline in L1 MEM to execute a STA operation (e.g., μop) and writeback complete to the OOO.
Store Coalescing Pipeline—Takes retired stores from the store buffer and coalesces them into the SCB in preparation for writing to memory.
Store Write Pipeline—Takes SCB entries and writes them into the data cache or a fill buffer.
DCU Fill Pipeline—Takes data from a fill buffer and fills it into the DCU, and moves modified data from the DCU into the eviction buffer.

In certain examples, loads are assigned a global identification (GLB ID) at allocation, which will have the side-effect of port binding the load to a specific AGU port, load port, and writeback port. In certain examples, loads hold an ICLB credit at allocation, and the exact ICLB entry is allocated after dispatch. In certain examples, after AGU, the load will cross the L1 MEM crossbar and arrive at a specific L1 MEM slice based on the linear address. In certain examples, once in L1MEM, the load will arbitrate for a load pipe, which it will eventually win. In certain examples, the load pipeline (e.g., load store unit or LSU) will be responsible for page translation, L1 data cache lookup, and resolving memory ordering against stores. In certain examples, the load will schedule down a load pipeline one or more times, until the load eventually binds to data and writes back the data to EXE and complete to the ROB. In certain examples, complete loads prepare the GLB to prove memory ordering correctness and will generate a machine clear event if they are found to be in violation. In certain examples, when the load writes back to the OOO, the ICLB entry will be deallocated. When the load is retired, the GLB entry will be deallocated.

In certain examples, stores are assigned a stored buffer identification (SB ID) at allocation, which is an exact pointer to an entry in the SAB, SDB, and SSB, e.g., the three logical components of the store buffer. In certain examples, the SB ID assignment has a side-effect of port binding the STA operation (e.g., μop) and STD operation (e.g., μop) to specific AGU and STD ports. In certain examples, stores have two component pops, a store address (STA) μop and a store data (STD) μop. In certain examples, the STA and the STD will schedule independently, and may arrive in L1 MEM in any order. In certain examples, while an STA is assigned to a specific L1 MEM slice based on linear address, the STD may arrive before an STA is known and therefore will be written into all slices of L1 MEM. In certain examples, when STAs arrive in L1 MEM, the STAs will be written into the SAB. In certain examples, when STDs arrive in MEM, the STDs will be written into the SDB. STAs will arbitrate for and eventually win the STA pipeline. In certain examples, the STA pipeline will be responsible for page translation, resolving memory ordering against loads, and sending the FE a packet to check for SMC violations. In certain examples, the store will hold its SAB, SDB, and SSB entries after retirement.

In certain examples, after retirement, stores in a slice will be moved from the SAB, SDB, and SSB into the store coalescing buffer (SCB) following age-order within a slice. In certain examples, when a store is moved into the SCB, it will deallocate the SAB, SDB, and SSB entries and eventually return the SBID to OOO for use in younger stores. In certain examples, L1 MEM slices will coordinate SBID return so that buffer entries are returned in order, despite different slices going out-of-order to move stores into the SCB. In certain examples, stores may merge into existing SCB entries following specific rules to make them (e.g., x86) Total Store Ordering compliant. In certain examples, the oldest SCB entries in the machine, across all MEM slices, will be scheduled to a Store Write pipeline to attempt to write the L1 data cache or a Fill Buffer.

TABLE 3
Example L1 MEM Parameters per L1 MEM Slice

| Name | Size | |
|---|---|---|
| L1 MEM Slices | 4 | slices |
| DCU size | 64 | KB |
| DCU organization | 128 sets, 8 ways, | |
| | 64 bytes per line | |
| Small DTLB entries | 256 | entries |
| Small DTLB organization | 64 sets, | |
| | 4 ways | |
| Large DTLB entries | 64 | entries |
| Large DTLB organization | 16 sets, | |
| | 4 ways | |
| XLarge DTLB entries | 16 | entries |
| XLarge DTLB organization | 1 set, | |
| | 16 ways | |
| GLB entries | 1024 | entries |
| ICLB entries | 144 | entries |
| SB entries | 576 | entries |
| SCB entries | 10 | entries |
| FB entries | 16 | entries |
| EVB entries | 8 | entries |
| SR entries | 4 | registers |

TABLE 4
Example L1 MEM Pipelines per L1 MEM Slice

| Name | Abbreviation | Pipes | Summary |
|---|---|---|---|
| Load Receipt | flr | 16 | Receives all loads |
| Pipe | | | after dispatch & AGU |
| ICLB Scheduling | fls | 4 | Schedules loads out |
| Pipe | | | of ICLB into load pipe |
| Load Pipe | fld | 4 | Executes loads in L1 MEM |
| STA Receipt | fsr | 12 | Receives all STAs |
| Pipe | | | after dispatch & AGU |
| SAB Scheduling | fss | 3 | Schedules STAs out |
| Pipe | | | of SAB into STA pipe |
| STA Pipe | fst | 3 | Executes STA pops |
| | | | in L1 MEM |
| STD Pipe | fsd | 12 | Receives all STDs after |
| | | | dispatch & execute |
| Store Coalescing | fsc | 1 | Merges senior stores |
| Pipe | | | into SCB entries |
| Store Write | fsw | 1 | Writes SCB entries |
| Pipe | | | to memory |
| DCU Fill Pipe | ffl | 1 | Fills lines into the DCU |

### L2 MEM

In certain examples, memory circuitry 104 includes another level of memory, e.g., MEM L2 circuitry 116. In certain examples, the L2 MEM 116 provides two main services to the core: first, it provides access to the (e.g., larger than L1) (e.g., 16M) L2 cache, and second, it serves as the interface to the rest of the system, e.g., the System-on-Chip (SoC). As such, in certain examples, the L2 MEM 114 has interfaces with the Front End (FE) circuitry 102, L1 MEM 114, PMH circuitry 118, prefetcher circuitry 120, and other SoC components, e.g., via IDI.

In certain examples, in order to provide access to the L2 cache, the L2 MEM 116 is tasked with accepting requests from the FE circuitry 102, L1 MEM 114, PMH circuitry 118, and prefetcher circuitry 120. In certain examples, core 100 is a high-performance core that requires high amounts of bandwidth to the L2 cache memory. In certain examples, to provide that bandwidth the L2 cache memory of the L2 MEM is partitioned into multiple (e.g., 4) L2 slices.

In certain examples, each L2 slice has its own:
Direct Request Interface (DRI)—L1 MEM request interface, each L2 MEM slice can take requests directly from its corresponding L1 MEM slice.
Shared Request Interface (SRI)—Shared interface that combines requests from the FE, PMH, and Prefetcher.
Second level queue (SLQ) unit—Which holds and schedules requests to the SL and IDI pipelines.
SL pipeline control unit—Which encapsulates the SL pipeline.
IDI (Intra-Die Interconnect) Control unit—which encapsulates the IDI pipeline. Runs in parallel to the L2 pipeline.
L2 Cache Portion (L2$)—A (e.g., 4M) piece of the L2 cache.
XQ unit—Which holds and schedules L2 miss requests to the SoC.
VQ unit—Which holds and schedules L2 cache eviction requests and snoop data to the SoC

In certain examples, the L2 slices are designed to be physical address isolated (e.g., a physical address can be found in one and only one slice) and operate in parallel. In this way the L2 MEM can process up to the number of slices (e.g., 4) L2 cache requests in parallel.

In certain examples, to serve as the interface to the SoC, the L2 MEM 116 is also tasked with sending out core requests that missed the core caches to the SoC and accepting data and state for those requests from the SoC. In certain examples, the L2 MEM 116 is to accept and process all requests from the SoC, e.g., including, but not limited to, snoop requests, bus lock handling requests, and interrupt requests. In certain examples, core 100 uses high amounts of memory bandwidth from the SoC, e.g., and to provide it, the IDI portion of L2 MEM is partitioned into multiple (e.g., 2) IDI slices.

In certain examples, each IDI slice contains its own:
SnpQ (Snoop Queue) unit—Which holds, schedules, and process SoC snoop requests.
IDI (Intra-Die Interconnect) unit—Which schedules and converts XQ requests/signals into SoC requests/signals and vice versa.
FIL (Fabric Interface Logic) unit—Which contains the logic that the core provides to the SoC when the core is in a powered down state.

In certain examples, as with the L2 slices, the IDI slices are designed to be address isolated and operate in parallel. In this way the IDI slices can process up to the number of IDI slices (e.g., 2) L2 cache miss requests at the same time.

In certain examples, L2 MEM is responsible for the processing, sending, and receiving of interrupts, e.g., by an Advanced Programmable Interrupt Controller (APIC). In certain examples, where interrupts are not dependent on a physical address, the APIC is a single non-sliced unit.

TABLE 5
Example L2 MEM Parameters per L2 MEM Slice

| Name | Size | |
|---|---|---|
| L2 MEM Slices | 4 | slices |
| L2 MEM IDI Slices | 2 | slices |
| L2$ size | 4 | MB |
| L2$ organization | 8192 sets, 8 ways, | |
| | 64 bytes per line | |
| SLQ entries | 12 | entries |
| XQ entries | 44 | entries |
| VQ entries | 18 | entries |

| | |
|---|---|
| SnpQ entries per | 24 entries |
| IDI slice | per IDI slice |

TABLE 6
Example Second Level (SL) MEM Pipelines per L2 MEM Slice

| Name | Abbreviation | Pipes | Summary |
|---|---|---|---|
| SL Pipe | SGP | 1 | Processes all L2$ transactions |
| IDI Pipe | SID | 1 | Creates IDI transactions, |
| | | | runs parallel to L2 pipe |

### Page Miss Handler (PMH)

In certain examples, page walker(s) are in a non-sliced L1 MEM circuitry, and all loads as part of the page walk would therefore go to the L1 MEM circuitry. However, with L1 addresses being sliced, missing a TLB entry in some location (e.g., some load in L1, something in L0, some prefetch, or some instruction cache (5) request) would generate a page walk with loads that could go to any slice. Certain examples herein solve this by building a separate page miss handler (PMH), allocate translation request buffers (TRBs), and send the page walk requests someplace global (e.g., outside of the L1/L2 slices). In certain examples, a “global page walk” is thus performed because of the address slicing.

In certain examples, the memory circuitry 104 includes page miss handler (PMH) circuitry 118 to service page translation misses on behalf of the first level TLBs, translating linear addresses into physical addresses, and producing TLB entries to fill the first level TLBs. In certain examples, the PHM circuitry 118 includes a second-level TLB queue (STLBQ) to receive requests, a (e.g., large) second-level TLB, a pipelined page walker state machine capable of handling multiple requests in flight, page walk caches, virtualization page walk caches, etc.

In certain examples, the PMH circuitry 118 will provide translation services for the front-end circuitry 102 as well as the L1 MEM Slices, L0 MEM Clusters, and/or the prefetcher circuitry 120. In certain examples, each L1 MEM slice, L0 MEM cluster, prefetcher circuitry and the FE circuitry may send address translation requests to the PMH circuitry.

In certain examples, the L1 MEM slices, L0 MEM slices, and the prefetcher circuitry 120 will collect requests locally into a Translation Request Buffer (TRB) before sending the requests to the PMH circuitry 118. In certain examples, the PMH circuitry 118 will receive these requests into the STLBQ, a request holding structure positioned before the STLB pipeline in the PMH.

In certain examples, the STLBQ will arbitrate ready requests into two STLB pipelines, e.g., where the requests will check a (e.g., large) second-level TLB (STLB) for translation, and either hit or miss. In certain examples, STLB hits will fill into the first level TLBs (e.g., DTLB, ZTLB, and/or ITLB).

In certain examples, STLB misses will arbitrate for a free page walker that will perform page walks. In certain examples, once a page walker is allocated, the STLBQ entry is put to sleep and does not arbitrate for the STLB pipeline until the walk completes. In certain examples, page walks will first check, in parallel, a set of page walk caches (PXEs) to find the deepest matching level of the page table. In certain examples, the page walkers will resume the walk from this deepest matching state. In certain examples, when a page walk is successfully complete, the page walker will write the translation into the STLB (and corresponding requester first level TLB) and wake up STLBQ entries that were sleeping as a result of matching the ongoing PWQ entry. In certain examples, the entry that allocated the PWQ entry will get deallocated after first level TLB fill without having to go down the STLB pipeline again.

In certain examples, the STLBQ entries will arbitrate again for STLB pipeline, and if they hit in STLB, then the STLB will fill the first level TLBs.

In certain examples, in order to keep the DTLBs in sync with each other (e.g., and the ZTLBs in sync with each other), the PMH circuitry 118 will also hold a primary copy of the DTLB and ZTLB, e.g., which will be checked for duplicates before sending fills to the L1 slices, prefetcher circuitry, or L0 clusters.

In certain examples, the PMH circuitry is responsible for choosing replacement ways in the first level MEM TLBs (e.g., DTLB and ZTLB, but not ITLB). In certain examples, to accomplish this, the L0 TLBs and L1 TLBs will send the PMH circuitry sampled least recently used (LRU) update packets, providing a partial view of which TLB entries are actively being used by the L1s and the L0s. In certain examples, the PMH will update the L1 (or L0) LRU array based on these samples, and then choose a victim way based on this local view of TLB LRU.

### Loads

In certain examples, each load is assigned a unique identifier (LBID) and a store “color” (e.g., SBID) at allocation time in OOO Circuitry. In certain examples, the LBID is an entry in the Global Load Buffer (GLB) and it is allocated in program order. In certain examples, the store color is the SBID of the youngest store that is older than the load and is used in MEM Circuitry for determining the range of stores in the store buffers that the load has to order against. In certain examples, memory μops wait in the MEM RS in OOO cluster until their data operands are ready, after which the MEM RS dispatches the loads (and STAs) out of order to the address generation unit (AGU) in EXE as well as to MEM Circuitry. In certain examples, the dispatched load (e.g., without linear address) travels over the MEM crossbar (e.g., over a slower connection) while the address is being generated in AGU. In certain examples, after the linear address is generated in AGU, the packet is sent over the crossbar towards L1 slices (e.g., over a faster connection) and thus reaches the slices soon after the load payload. In certain examples, the dispatched load payload reaches L1 slices (e.g., approximately half a cycle) before the generated linear address, with enough time for it to be decoded just in time to use with the linear address. In certain examples, once the address for the load arrives, each slice checks if the address belongs to the slice's address range by checking certain bits (e.g., bits [7:6]). In certain examples, if the load belongs to the slice, the slice tries to immediately send the load down the L1 mem pipeline if there are no other existing transactions that require the pipe, and writes the load information in the ICLB and GLB. In certain examples, the load looks up DTLB to obtain a physical address translation and in parallel looks up the L1 cache tag. In certain examples, the load uses MEM L1 pipeline to retrieve data either from the L1 cache, from an older store, or from higher levels of the memory hierarchy (L2 slice) if the data is not present in the L1 slice. In certain examples, this may take multiple trips through the MEM L1 pipeline. In certain examples, once the load has data (or the load detects a fault), it writes back the data to EXE Circuitry and notifies OOO of its completion status, deallocating the ICLB. In certain examples, the load remains in the GLB such that memory ordering checks can be performed on it until it retires in OOO.

In certain examples, each OOO Cluster can dispatch up to a threshold (e.g., 4) memory μops from the MEM RS towards a threshold (e.g., 4) EXE AGUs. In certain examples, the memory μops are bound to the AGU port based on (e.g., the last 2 bits of) the LBID (loads) or SBID (stores). In certain examples, an L1 slice can receive a threshold (e.g., 4) loads from each of the threshold (e.g., 4) OOO clusters per cycle (e.g., for a total of 16 loads). In certain examples, MEM guarantees that it will sink all loads that it receives from OOO by providing sufficient storage (GLB), write ports, and a crediting mechanism for ICLB. In certain examples, each L1 MEM slice has a plurality of (e.g., 4) pipes dedicated for loads, separate from STA pipes. In certain examples, to simplify scheduling, the loads are bound to a specific mem pipeline based on (e.g., the two least significant bits (LSB) of the LBID)). In certain examples, each load pipeline has its own scheduler that will select the oldest ready load only from the subset of loads that arrived on the AGU port with the same number. For example, where L1 mem pipeline 0 will only select between the loads that arrived on AGU port 0 from any cluster. In certain examples, each of the pipes will have a dedicated port for reading the DTLB and L1 cache tag, and for comparing their address against store buffers; two load pipes will share a port for reading data from the L1 cache, e.g., where all pipes will share a port for reading data from one of the L2 Store Data Buffer (SDB) partitions.

### Stores

In certain examples, in a given cycle, each OOO/EXE cluster can issue a first threshold (e.g., 3) STAs and a second threshold (e.g., 3) STDs, which are broadcasted to all L1 MEM slices. In certain examples, each L1 Mem slice is to accept all of a plurality of (e.g., 12) STAs and a plurality of (e.g., 12) STDs.

In certain examples, DispatchSTA packet and the associated ExecuteAGU packet come from the same port. In certain examples, Di spatchSTD packet and the associated ExecuteSTD packet come from the same port. In certain examples, each STA pipeline is bound to the corresponding stores port, e.g., store sent from AGIJ port0 goes to STA pipe0, etc. In certain examples, each L1 slice has a same number of (e.g., 3) STA pipes as OOO/EXE duster can send stores over the number of (e.g., 3) ports.

In certain examples, the STAs are received and saved in the Store Address Buffer (SAB) structure. In certain examples, along the path of writing the SAB, linear address (e.g., bit [7:6] of the linear address) of the incoming store is compared with the SliceID of the receiving slice, and the result is stored in SAB.inslice. In certain examples, this attribute is broadly used within L1 Mem Slice, e.g., wherever the store needs to be recognized either as in slice or out of slice.

In certain examples, the STDs are received and saved in the SDB (Store Data Buffer) structure.

In certain examples, the STAs received could arbitrate for its binding STA pipeline right away if there are no older STAs from the SAB or SAB skid stage. In certain examples, the winning STA will flow down the pipeline and gets address translated and update SAB and SSB (Senior Store Buffer). It could be blocked and ended up re-running the STA pipeline multiple times.

In certain examples, once OOO notifies Mem that a store/stores are retired, MEM slices move the store retirement pointer over the SSB structure and move forward to the senior store pipelines. In certain examples, a store stays in SAB/SDB/SSB until it's selected and succeeds in writing into SCB (Store Coalescing Buffer), e.g., this is when the SB (Store Buffer) entry could be deallocated. In certain examples, a store/store-group stays in SCB until it is selected and succeeds in writing into L1D$ or FB, e.g., this is when the SCB entry is deallocated.

### Pipelines

In certain examples, each slice of L1 MEM has its own set of one or more of the following pipelines:

Load Receipt Pipeline—Receives load dispatch and AGU payloads from OOO & EXE and writes the payload into an ICLB entry.
ICLB Scheduling Pipeline—Chooses oldest ready load on a load port from the ICLB and tries to schedule it into the load pipeline.
Load Pipeline—The main load pipeline in L1 MEM to execute a load and write back its results. Store Address Receipt Pipeline—Receives store address μop payloads and writes them into the store address buffer.
SAB Scheduling Pipeline—Chooses oldest ready STA on a STA port from the SAB and tries to schedule it into the store address pipeline.
Store Data Pipeline—Receives store data payload and writes it into the store data buffer. Store Address Pipeline—The main store address pipeline in L1 MEM to execute a STA μop and writeback complete to the OOO.
Store Coalescing Pipeline—Takes retired stores from the store buffer and coalesces them into the SCB in preparation for writing to memory.
Store Write Pipeline—Takes SCB entries and writes them into the data cache or a fill buffer. DCU Fill Pipeline—Takes data from a fill buffer and fills it into the DCU, and moves modified data from the DCU into the eviction buffer.

### Prefetcher Circuitry

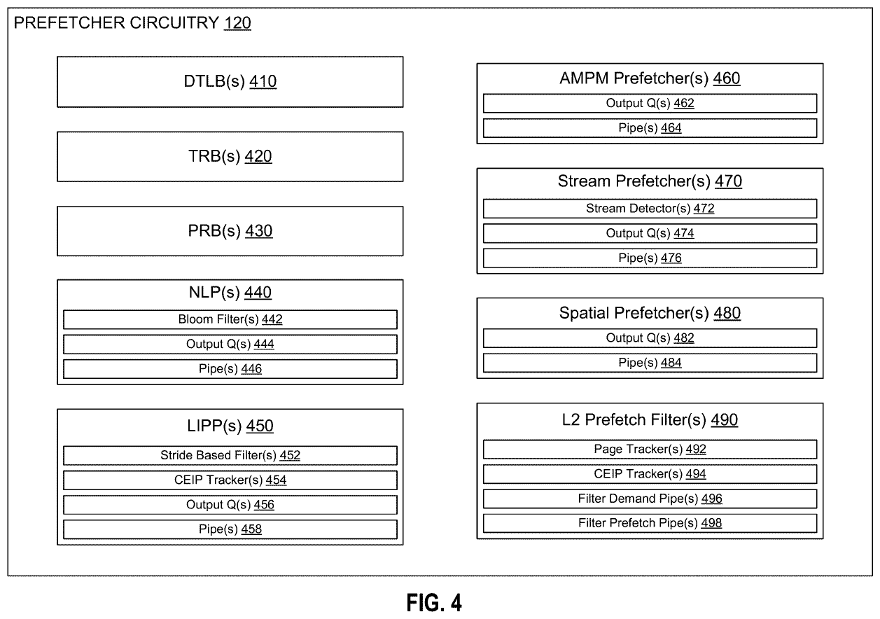

FIG. 4 illustrates a more detailed block diagram of prefetcher circuitry 120 (e.g., as shown in FIG. 1 and FIG. 3). As shown in FIG. 4, prefetcher circuitry 120 may include one or more data translation lookaside buffers (dTLB) 410; one or more translation request buffers (TRBs) 420; one or more prefetch recycle buffers (PRBs) 430; Next_Line Prefetcher(s) (NLP) 440 including bloom filter(s) 442, output queue(s) 444, and pipeline(s) 446; Linear Instruction Pointer Prefetcher(s) (LIPP) 450 including stride-based filter(s) 452, CEIP tracker(s) 454, output queue(s) 456, and pipeline(s) 458; Access Map Pattern Matching (AMPM) prefetcher(s) 460 including output queue(s) 462 and pipeline(s) 464; stream prefetcher(s) 470 including stream detector(s) 472, output queue(s) 474, and pipeline(s) 476; spatial prefetcher(s) 480 including output queue(s) 482 and pipeline(s) 484; and/or L2 prefetch filter(s) 490 including page tracker(s) 492, CET tracker(s) 494, filter demand pipeline(s) 4%, and filter prefetch pipeline(s) 498; each as described below.

In certain examples, the prefetcher circuitry 120 includes multiple L1 (e.g., L1 data (LID)) and L2 hardware prefetchers. In certain examples, the L1D and L2 caches send prefetch training events to the prefetcher circuitry, and the prefetcher circuitry in turn sends prefetch requests to the caches. In certain examples, prefetches serve to fill cache lines into the cache ahead of a predicted demand so that the demand access observes less latency.

In certain examples, each level of cache has its own set of hardware prefetchers. The or first level (FL) may have a Next Line Prefetcher (NLP) and/or a Linear instruction Pointer Prefetcher (LIPP). The L2 or second level (SL) may have an Access Map Pattern Matching prefetcher (AMPM), a Stream Prefetcher, and/or a Spatial Prefetcher. Each of these hardware prefetchers are described below, may target a different memory access pattern, and may have its own performance characteristics.

In certain examples, in addition to the hardware prefetchers, the prefetcher circuitry may include one or more prefetch filters. In certain examples, for each prefetch training event, each of the hardware prefetchers may generate several prefetches. It is possible, and in many instances likely, that there is significant overlap between the cache lines each prefetcher wants to prefetch. In certain examples, the prefetch filters serve to reduce the number of redundant prefetches that are sent to the caches, saving cache lookup bandwidth and power.

In certain examples, prefetcher circuitry may also include one or more data translation lookaside buffers (dTLB), one or more translation request buffers (TRBs), and/or one or more prefetch recycle buffers (PRBs).

In certain examples, a dTLBs of the prefetcher circuitry may be a copy of an L1 dTLB, and/or a prefetcher dTLB may be synchronized with an L1 dTLB.

In certain examples, a TRB of the prefetcher circuitry may record dTLB misses that are sent to the PMH for translation. The TRB may have a number (e.g., 8) of entries that may be allocated according to a TRB allocation policy. For example, several prefetches might attempt to get a translation from the dTLB simultaneously, however, if no translation is available (dTLB miss) and no matching page request is in flight in the PMH (TRB miss), only one new request may be made in the same cycle. Since only one new allocation to the TRB may be allowed each cycle, arbitration between prefetches may be performed if more than one prefetch requests a new page from the PMH. The TRB allocation policy may be static, may prioritize L2 prefetches over L1 prefetches, and/or may prioritize lower slice IDs over higher ones.

In certain examples, a PRB may be used to record prefetches that miss the dTLB and allocate a new entry or matched an existing entry in the TRB. Once the respective page is filled into the dTLB, matching prefetches may be marked as ready and re-dispatched out of the PRB.

In certain examples, a PRB may have a number of entries (e.g., 16), each with one or more of the fields shown in Table 7.

TABLE 7
Example PRB Entry Fields

| Name | Size | Description |
|---|---|---|
| virtual tag | 42-bits | virtual address tag of the prefetch |
| cache level | 1-bit | indicates which cache the prefetch |
| | | will be sent to (e.g., L1 or L2) |
| type | 2-bits | prefetch type (e.g., FE, data, RFO) |
| prefetch to L0 | 1-bit | indicates whether to also install |
| | | the cache line in the L0 |
| TRB_id | 3-bits | ID of the matching page entry in the TRB |
| ready | 1-bit | indicates whether the page is |
| | | available in the dTLB |

In certain examples, a prefetch may be added to the PRB only if it is able to get a TRB id, i.e., a new TRB entry may be allocated or it matches an existing entry in the TRB. If the prefetch missed in the TRB and fails to allocate a new entry (e.g., TRB is full or is not allowed to allocate according to the TRB allocation policy), the prefetch may be dropped.

In certain examples, when the PMH sends a response and a new page is installed in the dTLB, the PRB may be probed and any entries waiting on that page (e.g., matching TRB id) may be marked as ready (e.g., set ready bit). If the PMH detects a page fault, the matching PRB entries may be removed. When the ready bit is set, the entry is eligible for re-dispatch and may take priority over new prefetches.

In certain examples, the prefetcher circuitry connects to the L1D cache, the L2 cache, and the Page Miss Handler. If the LID and/or L2 caches are sliced, the prefetcher circuitry may connect to each slice separately.

In certain examples, an L1D to prefetcher circuitry interface may provide for sending prefetcher training packets and/or asserting FL throttling signals.

In certain examples, FL memory circuitry (e.g., one or more FL slices) may send one or more training packets (e.g., each FL slice may send one prefetch training packet per cycle) to the prefetcher circuitry. An FL slice may favor sending prefetch training packets for stores over loads and/or may round-robin between load and store pipelines as may be needed. Because the prefetchers may always be available to process a next set of incoming prefetch training packets, packets may be flopped instead of buffered at the prefetching circuitry and may be consumed by the FL prefetchers on the next cycle.

In certain examples, an FL prefetch training packet may include one or more of the fields shown in Table 8.

TABLE 8
Example First Level (FL) Prefetch Training Packet Fields

| Name | Size | Description |
|---|---|---|
| valid | 1-bit | valid bit indicates whether there is a |
| | | packet in the interface in the |
| | | current cycle |
| addr | 48-bits | address of the data access the FL sends |
| | | to prefetcher for training |
| | | (e.g., physical or virtual) |
| CEIP | 16-bits | compressed effective instruction pointer |
| | | of the instruction causing |
| | | the FL DCU access |
| cache_hit | 1-bit | whether this access was an FL DCU hit |
| type | 3-bits | type of training packet (e.g., load, |
| | | store, software prefetch NTA, |
| | | T1, T2) |
| phys_not_virt | 1-bit | 1 (e.g., physical address) or 0 |
| | | (e.g., virtual address) |

In certain examples, one or more FL slices may assert an FL throttling signal to the prefetcher circuitry to throttle incoming prefetches. The prefetcher circuitry may respond to the signal (e.g., from an FL slice) by stopping sending prefetches (e.g., to the FL slice), without affecting prefetches already in flight.

In certain examples, an FL throttling signal may be implemented as shown in Table 9.

TABLE 9
Example First Level (FL) Throttling Signal

| Name | Size | Description |
|---|---|---|
| stall | 1-bit | signals the prefetcher circuitry to |
| | | not send any prefetcher request to that |
| | | FL slice when asserted |

In certain examples, a prefetcher circuitry to L1D interface may provide for sending FL prefetch requests. The prefetcher circuitry may send one or more prefetch requests to the first level (e.g., one per cycle). At the FL, up to any number (e.g., four) prefetch requests may be buffered, before the FL sends a signal to stop sending additional requests. An FL slice-side buffer may be drained by the store write pipe with a low priority (i.e., demand stores go first), in connection with performing the cache hit check and fill buffer allocation, as may be needed.

In certain examples, an FL prefetch request may include one or more of the fields shown in Table 10.

TABLE 10
Example First Level (FL) Prefetch Request Fields

| Name | Size | Description |
|---|---|---|
| valid | 1-bit | valid bit indicates whether there is a |
| | | packet in the interface in the |
| | | current cycle |
| phys_addr | 40-bits | physical address of the cacheline that |
| | | will be prefetched into the FL |
| | | DCU |
| CEIP | 16-bits | compressed effective instruction pointer |
| | | of the instruction causing the |
| | | FL DCU access that caused this prefetch |
| type | 3-bits | type of prefetch (e.g., read, RFO, |
| | | software Prefetch NTA, T1, T2) |

In certain examples, an L2 to prefetcher circuitry interface may provide for sending prefetcher training packets and/or asserting SL throttling signals.

In certain examples, SL memory circuitry (e.g., one or more SL slices) may send one or more training packets (e.g., each SL slice may send one prefetch training packet per cycle) to the prefetcher circuitry. These packets may be sent as soon as SL cache hit/miss information is known. Because the prefetchers may always be available to process a next set of incoming prefetch training packets, packets may be flopped instead of buffered at the prefetching circuitry and may be consumed by the SL prefetchers on the next cycle.

In certain examples, an SL prefetch training packet may include one or more of the fields shown in Table 11.

TABLE 11
Example Second Level (SL) Prefetch Training Packet Fields

| Name | Size | Description |
|---|---|---|
| valid | 1-bit | valid bit indicates whether there is |
| | | a packet in the interface in the |
| | | current cycle |
| addr | 42-bits | address of the data access the SL |
| | | sends to prefetcher for training |
| | | (e.g., physical or virtual) |
| CEIP | 16-bits | compressed effective instruction |
| | | pointer of the instruction causing |
| | | the SL access |
| cache_hit | 1-bit | whether this access was an SL cache hit |
| type | 3-bits | type of training packet (e.g., read, |
| | | RFO, code, software prefetch |
| | | NTA, T1, T2) |
| phys_not_virt | 1-bit | 1 (e.g., physical address) or 0 |
| | | (e.g., virtual address) |

In certain examples, one or more SL slices may assert an SL throttling signal to the prefetcher circuitry to throttle incoming prefetches. The prefetcher circuitry may respond to the signal (e.g., from an SL slice) by stopping sending prefetches (e.g., to the SL slice), without affecting prefetches already in flight.

In certain examples, an SL throttling signal may be implemented as shown in Table 12.

TABLE 12
Example Second Level (SL) Throttling Signal

| Name | Size | Description |
|---|---|---|
| stall | 1-bit | signals the prefetcher circuitry to not send |
| | | any prefetcher request to that |
| | | SL slice when asserted |

In certain examples, a prefetcher circuitry to L2 interface may provide for sending SL prefetch requests. The prefetcher circuitry may send one or more prefetch requests to the second level (e.g., four per cycle), which may include any number of request ports to receive the requests. The SL request ports may be divided to support a number and/or rate of requests (e.g., one request per cycle per port) based on address bits (e.g., bits [7:6] of the physical address).

In certain examples, memory circuitry may include one or more (e.g., one per SL slice) unified request interface (e.g., SRI) shared by the Front End, P M H, and Prefetcher, which may be used by the SL request ports. The interface may be a stall-based interface, so as long as a particular port is not stalled, the prefetch circuitry may insert a request into the port (e.g., one request per cycle into the port).

In certain examples, each port may see different minimum latencies because the distance from the prefetcher circuitry to a SL slice (e.g., slice0) may be significantly different from the distance from the prefetcher circuitry to a different SL slice (e.g., slice3). Instead of having all ports have the same worst-case latency, implementations may allow variable latencies so slices with shorter distances to travel can recover some performance.

When prefetch requests arrive at the SL slices, they may be consumed immediately (e.g., by going down an SL prefetch pipeline) or they may be buffered (e.g., in an SL queue (SLQ)) along with other requests to the SL circuitry.

The bit fields of the request interface (e.g., SRI) may be a superset of Front End, PMH, and prefetcher circuitry so not all bit fields might be used by the prefetch circuitry (e.g., unused bit fields may be driven to 0's). In certain examples, an SL prefetch request may include one or more of the fields shown in Table 13.

TABLE 13
Example Second Level (SL) Prefetch Request Fields

| Name | Size | Description |
|---|---|---|
| valid | 1-bit | valid bit indicates whether there is |
| | | a packet in the interface in the |
| | | current cycle. |
| req_id | 5-bits | not used by prefetch requests |
| phys_addr | 46-bits | physical address of the line being |
| | | requested (e.g., prefetch requests |
| | | may use cacheline [45:6] address) |
| req_size | 1-bit | the size in bytes of the request |
| | | (may be used for PMH uncacheable |
| | | requests only); prefetch requests |
| | | may be considered 64B in size (not |
| | | used by prefetch requests) |
| req_type | 4-bits | request type code (e.g., read or RFO) |
| self_snoop | 1-bit | not used by prefetch requests |

In certain examples, a prefetcher circuitry to PMH interface may provide for sending requests to the PMH. In response to DTLB misses, the prefetcher circuitry may request the STLB/PMH to perform page translation. An implementation may provide for one request to be sent per cycle per slice.

In certain examples, page misses in the prefetcher circuitry may be collected in a Translation Request Buffer (TRB) and sent to the PMH circuitry. The PMH circuitry may provide storage for the translation requests, therefore the PMH may receive any translation requests sent to the PMH.

In certain examples, a PMH request packet may include one or more of the fields shown in Table 14.

TABLE 14
Example PMH Request Packet Fields

| Name | Size | Description |
|---|---|---|
| valid | 1-bit | valid bit indicates whether there is a |
| | | packet in the interface in the |
| | | current cycle. |
| phys_addr | 34-bits | physical address bits to the smallest |
| | | page boundary supported by |
| | | the core |
| is_physical | 1-bit | certain uops (e.g., Load.Phys |
| | | set this bit to true) |
| is_at_ret | 1-bit | set to true when the requesting |
| | | load/STA is the oldest in the |
| | | machine |
| slice ID | 2-bits | slice ID of the load/STA/prefetch request |
| needs_write | 1-bit | true for stores |
| is_user | 1-bit | requesting instruction is in user mode |

In certain examples, a PMH to prefetcher circuitry interface may provide for sending packets from the PMH to the prefetcher circuitry.

In certain examples, the PMH may send DTLB fill responses, which may include one or more of the fields to be filled into the DTLB (e.g., as shown in Table 15), one or more of which may be sent to the prefetcher circuitry.

TABLE 15
Example DTLB Fill Packet Fields

| Name | Size | Description |
|---|---|---|
| dtlb_fill | 1-bit | indicates that the DTLB is to be filled with the translation in |
| | | this packet |
| dtlb_page_size | 2-bits | indicates which of the page size DTLBs is to be filled (e.g., 4k, |
| | | 64k, 2M, 1G); also called effective page size |
| dtlb_fill_way | 2-bits | indicates which way of the DTLB specified by dtlb_page_size |
| | | is to be filled; the set is determined from wakeup_linaddr |
| phys_addr | 34-bits | physical address bits to the smallest page boundary in the core |
| | | (e.g., PA[45:12]) |
| global | 1-bit | returns true if this is a global page, which may be important for |
| | | invalidations |
| memtype | 3-bits | memory type (e.g., UC, USWC, write through, write protect, |
| | | write back) |
| write | 1-bit | indicates that this page is allowed to be written (e.g., stores are |
| | | allowed to use this translation) |
| user | 1-bit | indicates that this page is allowed to be accessed by user |
| | | transactions |
| dirty | 1-bit | indicates that this page is already marked as dirty; if stores try |
| | | to access this translation and dirty bit is not set, they will need |
| | | to go to PMH and set this bit before using the translation |
| phys | 1-bit | indicates this translation was for physical accesses (e.g., pages |
| | | where the virtual address matches the physical address, used |
| | | by uops like load_phys or store_phys) |
| csrr | 1-bit | indicates this range is in the core SRAM region (e.g., the walk |
| | | was done for a physeg_supovr request and only |
| | | physeg_supovr uops can use this translation) |
| avrr | 1-bit | indicates that this translation hit the virtual apic range |
| *rr | 5-bits | this walk hit a special range register region, so special |
| | | behavior may be needed in L1 for uops that hit this translation |
| | | (e.g., AMRR) |

In certain examples, the PMH may send TRB deallocation responses (e.g., to indicate that the PMH has finished using the resources associated with the TRB entry in the prefetcher circuitry and/or the TRB entry may be deallocated and reused for another translation).

In certain examples, a TRB deallocation response may be implemented as shown in Table 16.

TABLE 16
Example TRB Deallocation Response

| Name | Size | Description |
|---|---|---|
| trb_ealloc | 1-bit | indicates that the TRB entry specified |
| | | in this packet may be deallocated |
| trb_eid | 3-bits | the TRB entry that is to be deallocated |

In certain examples, L1D prefetching, may be implemented in hardware by a Next Line Prefetcher (NLP) and/or a Linear Instruction Pointer Prefetcher (LIPP) as described below.

In certain examples including an NLP, the NLP may prefetch the next line for each access, regardless of whether the access is a cache hit or miss or whether the access is a read or a write. In certain examples, for each input training demand, the next (e.g., +1) cache line address may be computed (e.g., for both L1 hits and L1 misses) as the prefetch address. The generated prefetch address may be passed through a local bloom filter to eliminate redundant prefetches before the prefetch is added to NLP's output queue.

In certain examples, an NLP may include a private bloom filter to filter out redundant NLP prefetches. For example, the bloom filter may be implemented as a 2-generation bloom filter, with each generation having 1024 bits, for a total capacity of 2048 bits or 256 bytes.

In certain examples, both demand and NLP prefetches may be added to the filter, and the number (e.g., 32) of additions between transitions from one generation to the other (e.g., as described below) may be configurable. As one example, up to 16 bits may be written and 8 bits may be read per cycle (maximum write 8× prefetches and 8× demands, maximum read check 8× prefetches).

In certain examples, a generational bloom filter may include two parallel bloom filters of the same size (e.g., 1024 bits). One of these parallel bloom filters may be considered the old filter, and one may be considered young. When checking the bloom filter, both generations may be checked in parallel, and if either is a hit, then that counts as a hit. A miss in both generations may count as a miss. Additions to the generational bloom filter may be added (e.g., only) to the young filter. The old filter may remain unchanged, although it may still be used for checking. After adding a fixed or configurable number (e.g., 32, may be by default) of items to the young bloom filter, then a generational switch may be performed by clearing out the contents of the old filter and swapping the names (and functions) of the two bloom filters. The previous old filter, now empty, may become the new young filter, and new items may be added (e.g., only) to this filter. The previous young filter may become the new old filter, with no new items being added to it, although it may still be checked for hits.

In certain examples, an NLP may include an output queue divided into separate queues for each L1 slice. Each of these output queues may be a simple FIFO where each entry may contain a prefetch virtual address (e.g., 48 bits) and bits (e.g., 2) to indicate a type (e.g., read, RFO, etc.). In one example, each output queue may be 8 entries long, and 2 items may be added to each output queue per cycle. If an output queue runs out of capacity, the oldest item(s) may be popped off the front before adding new prefetches. As the output queue is drained and prefetches are sent to the L1D slice, prefetch addresses may be added to the bloom filter. In one example, all sliced output queues together may be implemented with 200 bytes of storage (e.g., 4 slices×8 entries×(48 VA bits+2 type bits).

In certain examples, an NLP output queue entry may include one or more of the fields shown in Table 17.

TABLE 17
Example NLP Output Queue Entry Fields

| Name | Size | Description |
|---|---|---|
| virt_addr | 48-bits | virtual address of the cache |
| | | line being prefetched |
| type | 2-bits | type of the L1 prefetch |
| | | access (e.g., load, store) |

In certain examples, an NLP may have eight prefetching pipelines, two for each of the four L1 slices. An L1 NLP pipeline may be implemented, for example, as shown in Table 18 and described below.

TABLE 18
Example L1 NLP Pipeline

| nlp01 | nlp02 | nlp03 | nlp04 |
|---|---|---|---|
| dispatch | compute_next_line | search_output_q | write_output_q |
| | | search_bloom_filter | write_bloom_filter |
| | | | generational_bf_switch |

In the n1p01 stage, a dispatch operation may be performed. For example, a dispatch operation may include sending a prefetch training packet down the NLP pipeline (as well as the other L1 prefetcher pipelines) when the prefetch training packet arrives from the L1.

In the n1p02 stage, a compute_next_line operation may be performed. For example, a compute_next_line operation may include generating the next line address by adding 64 to the training demand's byte address.

In the n1p03 stage, a search_output_q operation and/or a search bloom filter operation may be performed. A search_output_q operation, for example, may include searching the NLP's output queue for the next line address to avoid prefetching the same cache line more than once. A search bloom filter operation, for example, may include searching the bloom filter to avoid prefetching a cache line that was recently prefetched or that was recently observed as a training demand. Both generations of bloom filter may be checked, and if there is a match in either, the prefetch may be dropped.

In the n1p04 stage, a write_output_q operation, a write_bloom_filter operation, and/or a generational_bf_switch operation may be performed. A write_output_q operation, for example, may include adding the prefetch and type to the output queue if there was a miss in the bloom filter in the previous stage. A write_bloom_filter operation, for example, may include adding the training demand to the bloom filter. The prefetch addresses may be added to the bloom filter later as they are drained from the output queue and sent to their L1D slice. A generational_bf_switch operation, for example, may be performed after a number (e.g., 32) of items have been added to the bloom filter and may include clearing out the older of the two bloom filters and then beginning to add new items to it on the next cycle.

In certain examples including an LIPP, the LIPP may attempt to determine the byte address stride between successive iterations of the same instruction, as identified by the instructions CEIP. Once it has determined the stride for the instruction, the LIPP may prefetch several iterations ahead.

In certain examples, an LIPP may include a CEIP tracker to monitor the behavior of individual memory instructions, and may be indexed by the instruction's CEIP, which may also act as a tag for this structure. A CEIP tracker entry may keep track of a short history of recent strides, the most common direction of a stride, as well as several candidate prefetch offsets, along with their confidences.

In certain examples, a CEIP tracker entry may include one or more of the fields shown in Table 19.

TABLE 19
Example CEIP Tracker Entry Fields

| Name | Size | Description |
|---|---|---|
| CEIP | 16-bits | CEIP of the memory instruction |
| | | this entry tracks |
| prev_addr | 48-bits | virtual byte address of the |
| | | last training demand |
| stride_dir | 4-bits | saturating counter to track |
| | | most common direction of stride |
| stride_magnitude | 3 × 16-bits | magnitude of 3 most recent |
| | | observed strides |
| pref_offsets | 4 × 16-bits | magnitude of 4 candidate |
| | | prefetch offsets |
| pref_confidence | 4 × 4-bits | confidence of 4 candidate |
| | | prefetch offsets |

In certain examples, an LIPP may look for constant stride patterns in byte addresses between successive instances of the same load IP. After a stride has been identified for an IP, and some confidence is gained in it, the LIPP may prefetch a number (e.g., 16) of iterations ahead. The number of iterations may be configurable and/or by default. For example, if the stride for a load is determined to be 8 bytes, the next time the LIPP sees a training demand from that load instruction it will prefetch 16×8 bytes=128 bytes from the current demand.

In certain examples, each L1 slice may send two training packets to the prefetch circuitry each cycle, selected out of up to seven L1 access that may be happening that cycle (e.g., 4 reads and 3 writes), in which case LIPP only has visibility to 28% of all L1 activity, and the L1 activity may be significantly out of order. Therefore, the LIPP may be implemented with filtering because the true stride is only sometimes observable. For example, the LIPP may maintain a record of three recent strides and train on the smallest magnitude of those three because the true stride is not larger than the smallest stride observed but may be smaller. The LIPP may also track stride magnitude and direction separately. Direction may be tracked with a saturating counter that increases when a positive stride is seen and decreases when a negative stride is seen. In this way the LIPP may be more robust in the presence of out-of-order effects.

In certain embodiments, an LIPP may keep score between several smallest stride offsets in its three-stride history. The stride offset with the highest score, which is also above a fixed or configurable threshold, may be selected to generate a prefetch. To update the score of an offset, the scores of all the offsets may be decremented by a fixed or configurable amount, then the one(s) to have confidence raised may be increased by another fixed or configurable amount.

In certain examples, an LIPP may include an output queue divided into separate queues for each L1 slice. Each of these output queues may be a simple FIFO where each entry may contain a prefetch virtual address (e.g., 48 bits) and bits (e.g., 2) to indicate a type (e.g., read, RFO, etc.). In one example, each output queue may be 8 entries long, and 2 items may be added to each output queue per cycle. If an output queue runs out of capacity, the oldest item(s) may be popped off the front before adding new prefetches. In one example, all sliced output queues together may be implemented with 200 bytes of storage (e.g., 4 slices×8 entries×(48 VA bits+2 type bits).

In certain examples, an LIPP output queue entry may include one or more of the fields shown in Table 20.

TABLE 20
Example LIPP Output Queue Entry Fields

| Name | Size | Description |
|---|---|---|
| virt_addr | 48-bits | virtual address of the |
| | | cache line being prefetched |
| Type | 2-bits | type of the L1 prefetch |
| | | access (e.g., load, store) |

In certain examples, an LIPP may have eight prefetching pipelines, one for each input training demand from the L1 slices (2 per slice×4 slices). An L1 NLP pipeline may be implemented, for example, as shown in Table 21 and described below.

TABLE 21
Example L1 LIPP Pipeline

| lipp01 | lipp02 | lipp03 | lipp04 | lipp05 | lipp06 |
|---|---|---|---|---|---|
| dispatch | crosspipe_lip_check | read_lip_tracker_table | allocate_lip_tracker | crosspipe_write_check | writeback_lip_tracker |
| | | | compute_stride_magnitude | update_offset_scores | |
| | | | compute_stride_direction | | |
| | | | generate_prefetch_addr | enqueue_prefetch | |

In the lipp01 stage, a dispatch operation may be performed. For example, a dispatch operation may include sending a prefetch training packet down the LIPP pipeline (as well as the other L1 prefetcher pipelines) when the prefetch training packet arrives from the L1.

In the lipp02 stage, a crosspipe_lip_check operation may be performed. For example, a crosspipe_lip_check operation may include determining which pipes have the same CEIP and determining what should be read from the CEIP tracker structure, which may be done by a majority vote with a round-robin tie breaker. Pipelines with nothing read from the CEIP tracker generate no prefetches.

In the lipp03 stage, a read_lip_tracker table operation may be performed. For example, a read_lip_tracker table operation may include send a copy of the CEIP tracker table to each pipeline that wants it.

In the lipp04 stage, an allocate_lip_tracker operation, a compute_stride_magnitude operation, a compute_stride_direction operation, and/or a generate_prefetch_addr operation may be performed. If a pipeline tried to read something from the CEIP tracker table and it was a miss, an allocate_lip_tracker operation, for example, may include, initializing a new entry with the CEIP and the current training address as the previous address. A compute_stride_magnitude operation, for example, may include computing a stride magnitude between the CEIP tracker entry's previous address and the current training demand address. A compute_stride_direction operation, for example, may include computing a stride direction between the CEIP tracker entry's previous address and the current training demand address. A generate_prefetch_addr operation, for example, may include using the highest confidence prefetch stride offset that is above the prefetching threshold to generate a prefetch address (e.g., the base training demand address+(16×the highest confidence stride).

In the lipp05 stage, a crosspipe_write_check operation, an update_offset_scores operation, and/or an enqueue_prefetch operation may be performed. A crosspipe_write_check operation, for example, may include determining how much the saturating counter for the stride direction should change (e.g., by summing the directions from each pipeline with the same CEIP). Also, the pipeline with the smallest observed stride for this CEIP may be identified, to be recorded in the CEIP tracker's stride history. An update_offset_scores operation, for example, may include using the smallest stride from the current history to update the stride offset scores as described above. An enqueue_prefetch operation, for example, may include adding the prefetch for this pipeline to the appropriate prefetch output queue, using round robin tie breakers if more than two pipelines want to write to the same output queue in the same cycle.

In the lipp06 stage, a writeback_lip_tracker operation may be performed. For example, a writeback_lip_tracker operation may include writing back the CEIP tracker where it was found in the CEIP tracker table (e.g., overwrite the existing entry with this new updated version, without attempting to merge with the existing entry).

In certain examples, L2 prefetching may be implemented in hardware by an Access Map Pattern Matching (AMPM) prefetcher, a stream prefetcher, and/or a spatial prefetcher as described below.

In certain examples including an AMPM prefetcher, the AMPM prefetcher may analyze spatial maps to determine what cache lines should and should not be prefetched in the neighborhood of the current access.

In certain examples, an AMPM prefetcher may look at bitmaps representing recent demands and prefetches in the neighborhood of the current demand, then search for which cache lines should be prefetched next. These bitmaps may be called access and prefetch maps and may be supplied to the AMPM prefetcher from the L2 prefetch filter (e.g., described below). The L2 prefetch filter may supply access and prefetch maps for the current demand page, as well as the two adjacent pages (−1 and +1 pages). If the L2 prefetch filter is unable to supply one of these pages because of a filter bank conflict, or it does not have any information about that page, then a dummy map full of 0s may be supplied, and this map of 0s may be fed through the AMPM algorithm in place of that page's maps.

In certain examples, to generate prefetch candidates, the supplied access maps may be concatenated and rotated to be centered on the current demand access. Then, every cache line in a range (e.g., −32 cache lines to +32 cache lines) may be checked to see if it is a prefetch candidate. The range may be fixed or configurable, and may have maximum bounds (e.g., −32 and +32).

In certain examples, a cache line at offset +0 from the current demand may be considered a prefetch candidate if the bits corresponding to the −O and −2O offset cache lines are set to 1 in the rotated access maps. A cache line at offset −O from the current demand may be considered a prefetch candidate if the bits corresponding to the +0 and +2O offset cache lines are set to 1 in the rotated access maps. All (e.g., 64) candidate prefetches may be checked in parallel through a combinational circuit, and produce an output vector (e.g., 64-bit) of all candidate prefetches.

In certain examples, there may be a fixed or configurable window around the current demand access inside which as much confirmation is not needed to produce a candidate prefetch (e.g., within the window check only for −O (or +O for negative offsets) and ignore whether the −2O (or +2O) is also set before setting that bit in the candidate prefetch output vector).

In certain examples, to filter prefetch candidates after the prefetch candidate vector has been generated, it may be rotated back to be aligned with page boundaries (e.g., 4 KB). The resulting rotation may span across two pages, and the output of this rotation may be two vectors (e.g., 64-bits each).

In certain examples, the resulting two vectors are compared against the input prefetch maps from the L2 prefetch filter (e.g., described below) and the prefetch maps from the local output queue. Anything that has already been prefetched, whether by the AMPM prefetcher (as evidenced by the output queue) or by another L2 prefetcher (as evidenced by the input prefetch maps) may be filtered out. An empty vector may be substituted for any one or more pages not found in the output queue.

In certain examples, a 3-way bitwise AND may be performed between the rotated prefetch candidate vectors, the INVERSE of the prefetch vectors from the output queue, and the INVERSE of the input prefetch maps from the L2 prefetch filter (e.g., described below). The result of this operation may be a bitmap in which each 1 represents a cache line to be prefetched (according to the AMPM algorithm) that has not been prefetched yet.

In certain examples, an AMPM prefetcher may include an output queue with entries (e.g., 8) having a specialized format. Each entry may be tagged with a virtual page number (e.g., 48-12 bits), a bit vector representing cache lines to prefetch (e.g., 64 bits), a bit vector representing cache lines already prefetched (e.g., 64 bits), a pointer for each L2 slice (e.g., 4×6 bits) showing which cache line from the bit vector will be prefetched to that slice next, and type (e.g., 2 bits). For example, each entry may be 190 bits and the AMPM prefetcher output queue may be implemented with 190 bytes of storage.

In certain examples, an AMPM prefetcher output queue entry may include one or more of the fields shown in Table 22.

TABLE 22
Example AMPM Output Queue Entry Fields

| Name | Size | Description |
|---|---|---|
| virt_page_addr | 36-bits | virtual address of the |
| | | page this entry tracks |
| want_to_prefetch | 64-bits | bit vector of cache lines |
| | | to prefetch in this page |
| already_prefetched | 64-bits | bit vector of cache lines |
| | | already prefetched in this page |
| slice_pointers | 4 × 6-bits | pointer for where each |
| | | slice will prefetch next |
| type | 2-bits | type of the L2 prefetches in |
| | | this page (e.g., load, store) |

In certain examples, an AMPM prefetcher may have four pipelines. An AMPM prefetcher pipeline may be implemented, for example, as shown in Table 23 and described below.

TABLE 23
Example L2 AMPM Prefetcher Pipeline

| ampm01 | ampm02 | ampm03 | ampm04 | ampm05 | ampm06 | ampm07 | ampm08 |
|---|---|---|---|---|---|---|---|
| dispatch | merge_trains | rotate_inputs | generate_candi- | rotate_candi- | filter_redun- | coor- | add_to_output_q |
| | | | dates | dates | dants | dinate_add_to_output_q | |
| | | search_output_q | read_output_q | | | | allocate_output_q |

In the ampm01 stage, a dispatch operation may be performed. An AMPM pipeline may begin after the L2 prefetch filter (e.g., described below) is able to read out the access and prefetch maps to be used by the AMPM (or, if those maps cannot be found, dummy maps of all 0s may be generated). This stage may line up with the 12pfd05 stage of the L2 prefetch filter pipeline (e.g., described below).

In the ampm02 stage, a merge_trains operation may be performed. For example, a merge_trains operation may include ensuring that each demand to a region (e.g., 4 KB) shows up in the access maps within any other pipelines using overlapping regions.

In the ampm03 stage, a rotate_inputs operation and/or a search_output_q operation may be performed. A rotate_inputs operation, for example, may include rotating the access maps for the three input pages to be centered on the demand this pipeline is working on. The output of this stage may be a vector (e.g., 128 bits), with bits (e.g., 64) representing the access map data on either side of the current demand. A search_output_q operation, for example, may include searching the AMPM output queue for all three pages, so that a prefetch may be generated to any of them and/or redundant prefetches may be filtered out from any of them.

In the ampm04 stage, a generate_candidates operation and/or a read_output_q operation may be performed. A generate_candidates operation, for example, may include using the combinatorial algorithm described above to generate the vector (e.g., 64-bit) of candidate prefetches. A read_output_q operation, for example, may include reading out the want to_prefetch and already_prefetched vectors and OR-ing them together to represent what is to be prefetched or is already prefetched in this page (so no cache lines are redundantly prefetched, and repeating for all three pages this pipeline is interested in.

In the ampm05 stage, a rotate candidates operation may be performed. For example, a rotate candidates operation may include rotating the prefetch candidates back to be aligned on boundaries (e.g., 4 KB), resulting in two vectors (e.g., 64-bits each).

In the ampm06 stage, a filter redundants operation may be performed. For example, a filter redundants operation may include using the algorithm described above to combine the prefetch candidates with the input prefetch maps and the prefetch output queue information to generate bit vectors of candidate prefetches still to be prefetched.

In the ampm07 stage, a coordinate_add_to_output_q operation may be performed. For example, a coordinate_add_to_output_q operation may include (since it is possible that multiple pipelines want to prefetch to the same set of pages), each pipeline broadcasting the vector (e.g., 64-bits) of candidate prefetches it wants to issue to each page to the other pipelines, and each pipeline OR-ing together their own prefetch candidate bit vectors with what they see broadcast from other pipelines.

In the ampm08 stage, an add_to_output_q operation and/or an allocate_output_q may be performed. An add_to_output_q operation, for example, may include, for each page hit in the output queue that this pipeline wants to prefetch to, writing new prefetches to the output queue by OR-ing in the filtered vector (e.g., 64-bit) of prefetch candidates for that page with the want_to_prefetch bit vector that already exists. If the prefetch page is not already found in the output queue, an allocate_output_q operation, for example, may include adding a new entry, replacing the oldest entry (e.g., attach the appropriate type to this entry, initialize all slice pointers to the beginning of the page, zero out the want_to_prefetch and already_prefetched vectors, and then OR in all the candidate prefetch vectors from each pipeline that wants to issue prefetches to that page).

In certain examples including a stream prefeteher, the stream prefetcher may detect if the memory access pattern is generally in the positive or negative direction, then aggressively prefetch a series of +1 or −1 cache line addresses to attempt to stay ahead of the demand access stream.

In certain examples, a stream prefetcher may track accesses in the virtual memory space and try to prefetch a certain distance ahead of the current demand access. For example, it may track memory at page granularity (e.g., 4 KB) and identify if the memory access direction is generally positive or negative through that page. Once the direction is established, a series of prefetches may be issued to try to get ahead of the current demand stream.

In certain examples, each tracked page may have within it a “home line,” and around that home line there is a “near window” and a “far window” (each described below). The distance between subsequent demands within the page and its home line may be measured to control the prefetcher's behavior.

In certain examples, a stream prefetcher may include a stream detector to monitor memory activity within pages (e.g., 4 KB). Each page it tracks may have its own stream detector entry, which may be tagged with the virtual page number, to keep track of where to prefetch next, direction state, and direction counts to help determine prefetch direction.

In certain examples, there may be multiple (e.g., 32) stream detectors in a fully-associative structure, which may be replaced in a FIFO manner when looking up a page results in a miss. As one example, each stream detector entry may be 49 bits, and an array of stream detector entries may be implemented with 196 bytes of storage.

In certain examples, a stream detector entry may include one or more of the fields shown in Table 24.

TABLE 24
Example Stream Detector Entry Fields

| Name | Size | Description |
|---|---|---|
| virt_page_addr | 36-bits | virtual address of the |
| | | page this entry tracks |
| home_line | 6-bits | where to prefetch next |
| | | within this page |
| direction_state | 3-bits | stores stream confidence |
| | | and direction |
| count_positive | 2-bits | number of positive direction |
| | | memory accesses |
| count_negative | 2-bits | number of negative direction |
| | | memory accesses |

In certain examples, when a new page tracker is allocated, the home line represents the offset within the page of the initial demand access. After a prefetching pattern is established within the page, the home line's meaning changes to represent the next cache line that will be prefetched.

In certain examples, the near window may be a fixed or configurable region around the home line. By default, the near window may be anything within 16 cache lines of the home line. If a prefetching pattern has not yet been established for the current page, then a demand within the near window will increase confidence to begin prefetching, either by increasing the positive demand count or negative demand count. If either of those cross their fixed or configurable thresholds, then this page tracker transitions into prefetching mode. When in prefetching mode, near window hits indicate that prefetching in the appointed direction should continue.

In certain examples, a fixed or configurable far window (e.g., 32 cache lines, may be by default) lies outside the near window. If a demand outside the near window but within the far window is seen, it may be considered a situation in which enough prefetching has been done so prefetching may temporarily stop (i.e., have already prefetched far enough ahead to get good performance and further prefetching has a higher probability of being wasteful).

In certain examples, demand accesses outside the far window indicate that prefetching may be off course. If the demand was a cache hit, it may mean that the cache is doing its job (even if the prefetcher is not), so there may be no need for a change. If, however, there is a far window miss and a cache miss, the home line position may be reset to the current demand offset, and if in kickstart mode (described below) in this page, the entire detector may be reset and started from scratch in this page.

In certain examples, if the initial demand access to a page is a cache miss and is to the first few or last few cache lines in the page, then the page tracker may immediately enter a kickstart mode, and prefetching may begin immediately, without any further warmup.

Thereafter, the kickstarted page may behave the same as any other page that locked onto a prefetching pattern, except that the kickstarted page's prefetch degree may be configured separately from the standard prefetching degree, and kickstarted pages have may different behavior when missing the far window (see above).

By default, kickstart may be triggered by initially accessing either the first two (or other number), or last two (or other number) cache lines, but it may be configurable how many cache lines near the ends of the page trigger kickstart.

In certain examples, if the initial demand access to a page is a cache miss and the prefetch training packet contains a full-page prefetching hint, then the page tracker may immediately enter full-page prefetching mode, and prefetching may begin immediately, without any further warmup.

Thereafter, the full-page prefetching page may behave as usual, but with its own fixed or configurable prefetch degree (which may even include the entire page), and this page may entirely ignore near and far window hits and misses such that prefetching may continue until the whole page is prefetched.

In certain examples, a stream prefetcher may include, for each L2 slice, an output queue with entries (e.g., 8) having a specialized format. Each entry may include the virtual page number where prefetching is to be done, a home line pointing to the cache line that is next to be prefetched, a direction, and the remaining prefetch degree indicating how many prefetches from the current home line are still to be done in this page. For example, each entry may be 49 bits and the stream prefetcher output queue may be implemented with 196 bytes of storage (49 bits×8 entries×4 slices).

In certain examples, a stream prefetcher output queue entry may include one or more of the fields shown in Table 25.

TABLE 25
Example Stream Prefetcher Output Queue Entry Fields

| Name | Size | Description |
|---|---|---|
| virt_page_addr | 36-bits | virtual address of the |
| | | page this entry tracks |
| home_line | 6-bits | where to prefetch next |
| | | within this page |
| direction | 1-bit | the direction to prefetch |
| | | within the page |
| remaining_degree | 6-bits | number of remaining |
| | | prefetches requested so far |

In certain examples, a stream prefetcher may have a pipeline for each training demand that may be sent to the L2 per cycle (e.g., a total of four pipelines). A stream prefetcher pipeline may be implemented, for example, as shown in Table 26 and described below.

TABLE 26
Example L2 Stream Prefetcher Pipeline

| stream01 | stream02 | stream03 | stream04 | stream05 | stream06 |
|---|---|---|---|---|---|
| dispatch | search_detectors | read_detector | window_hits | update_counters | writeback_home_line |
| | merge_trains | | | update_dir_state | |
| | | allocate_detector | kickstart | | |
| | | | full_page_start | | |
| | | | | generate_prefetches | |
| | | | | check_output_q | write_output_q |

In the stream01 stage, a dispatch operation may be performed. A stream prefetcher pipeline may begin after the L2 prefetch filter (e.g., described below) is able to provide a full-page prediction for an access. This stage may line up with the 12pfd04 stage of the L2 prefetch filter pipeline (e.g., described below).

In the stream02 stage, a search_detectors operation and/or a merge_trains operation may be performed. A search_detectors operation, for example, may include performing an associative search of the (e.g., 32) stream detectors. A merge_trains operation, for example, may include checking the (e.g., four) stream prefetcher pipelines to identify pipelines that want to access the same stream detectors on the same cycle. Duplicates may be merged into the lowest-numbered pipeline. A single merged training packet may carry the information for all the training packets that merged into it. A merged packet may count as a cache miss if at least one of its constituents was a cache miss, and a full-page access if at least one of its constituents was a full-page access.

In the stream03 stage, a read_detector operation and/or an allocate detector operation may be performed. A read_detector operation, for example, may include reading out the information from each detector entry that was a hit. A allocate detector operation, for example, may include, for any detector search that was a miss, as well as a cache miss, creating a new stream detector, replacing the oldest stream detector in a FIFO manner. Newly allocated detectors may be tagged with the virtual page number, and the home line may be initialized to be the page offset of the training demand. If a merged training packet is allocating a new detector, then most convenient page offset (e.g., from the lowest numbered pipeline, the lowest value) may be used.

In the stream04 stage, a window_hits operation, a kickstart operation, and/or a full_page_start operation may be performed. A window_hits operation, for example, may include, for each of the training packets this pipeline is carrying, calculating the near and far window hits. If a new stream detector was just allocated, and one of the training demands is close enough to the page boundary, a kickstart operation, for example, may include marking this detector's direction state as kickstart with the appropriate direction. If a new stream detector was just allocated, and one of the training demands was marked with the full-page prefetch hint, a full_page_start operation, for example, may include marking this detector's direction state as full-page with the appropriate direction.

In the stream05 stage, an update counters operation, an update_dir_state operation, a generate_prefetches operation, and/or a check_output_q operation may be performed. An update counters operation, for example, may include updating the stream detector's positive and/or negative counts based on how many demands were above and/or below the home line. If in a non-prefetching state, an update_dir_state operation, for example, may include entering into the positive or negative prefetching state based on the state of the counters. If both the positive and negative counters exceed their thresholds on the same cycle, positive prefetching may win the tie breaker. A generate_prefetches operation, for example, may include determining how many prefetches, and in which direction, should be issued, based on the stream detector's direction state and the appropriate control registers (e.g., a different number of prefetches may be generated for full-page prefetching, kickstart, or regular prefetching). A check_output_q operation, for example, may include checking for the current page's presence in the output queue. If it is already there, then the entry may be updated on the next cycle, rather than allocating a new one.

In the stream06 stage, a writeback_home_line operation and/or a write_output_q operation may be performed. A writeback_home_line operation, for example, may include calculating a new homeline after determining how many prefetches, and in which direction, should be generated. The homeline may wrap around to the other end of the page after it exceeds the boundary in either direction. A write_output_q operation, for example, may include allocating a new output queue entry if there is not yet one for this page, or updating the current entry with a newly determined number of additional prefetches to be done.

In certain examples including a spatial prefetcher, the spatial prefetcher may prefetch several cache lines in the neighborhood of an L2 miss, as if it were fetching a larger cache block than the actual cache block size of the cache.

In certain examples, an L2 spatial prefetcher may create the illusion of having larger cache lines when there is a demand miss in the L2 cache. These larger cache lines (“spatial regions”) may be of a fixed or configurable size and/or may be any power of two size (e.g., in the range of 128 to 1024 bytes).

In certain examples, in response to an L2 miss, in addition to fetching the missing cache line, the spatial prefetcher prefetches all the other cache lines that are part of the miss's spatial region. The spatial regions may be aligned based on their size and/or not centered around the demand miss. All the other cache lines of the spatial region may be prefetched, regardless of where within the spatial region the miss happened. Therefore, sometimes the spatial prefetcher may prefetch in the positive direction, sometimes in the negative direction, and if the region size is big enough, sometimes it may prefetch in both directions at the same time.

In certain examples, a spatial prefetcher may include an output queue with entries (e.g., 8) having a specialized format. Each entry may include the region's address and a spatial bitmap in which each bit represents a cache line to be prefetched in that region. For example, each entry may be 64 bits and the spatial prefetcher output queue may be implemented with 64 bytes of storage (64 bits×8 entries).

In certain examples, the entries may be replaced in a round robin fashion. Two entries may be allocated per cycle, using round robin to determine which spatial prefetcher pipes get to allocate if there are more than two that want to allocate in a cycle.

In certain examples, a spatial prefetcher output queue entry may include one or more of the fields shown in Table 27.

TABLE 27
Example Stream Prefetcher Output Queue Entry Fields

| Name | Size | Description |
|---|---|---|
| virt_addr | 48-bits | virtual address of the first byte |
| | | in the spatial region to prefetch |
| spatial_bitmap | 16-bits | the cache lines remaining to be |
| | | prefetched in this spatial region |

In certain examples, a spatial prefetcher may have multiple (e.g., four) pipelines. A spatial prefetcher pipeline may be implemented, for example, as shown in Table 28 and described below.

TABLE 28
Example L2 Spatial Prefetcher Pipeline

| spatial01 | spatial02 | spatial03 |
|---|---|---|
| dispatch | coordinate_pipes | write_output_q |
| | search_output_q | |

In the spatial01 stage, a dispatch operation may be performed. According to the L2 prefetch filter demand pipeline (e.g., described below), training demands may dispatch to the L2 spatial prefetcher pipeline on the cycle after they dispatch down that pipeline. Therefore, the spatial01 stage lines up with stage 12pfd02 of the L2 prefetch filter pipeline.

In the spatial02 stage, a coordinate_pipes operation and/or a search_output_q operation may be performed. A coordinate_pipes operation, for example, my include the (e.g., four) pipelines communicating to ensure that each spatial region is prefetched only once. Also, the pipelines may express which cache line within the spatial region their training demand is from, so it is known not to prefetch those cache lines again. If more than one pipeline wants to prefetch the same spatial region, the pipeline with the lowest number may win and become the only pipeline that may write that spatial region to the prefetch output queue. A search_output_q operation, for example, may include searching the spatial prefetch output queue to further prevent redundant prefetching.

In the spatial03 stage, a write_output_q operation may be performed. If both checks in previous stage determined that this pipeline should write this spatial region to the output queue, then a write_output_q operation, for example, may include writing this spatial region to the output queue. The byte address of the beginning of the spatial region is written, along with a bit map of everything to be prefetched. In the bitmap, a 1 may indicate that the corresponding cache line is still to be prefetched, and a 0 may indicate that the corresponding cache line should not be prefetched. An attempt to write a spatial region into the output queue with a bitmap of all 0s is possible, which would indicate no prefetching should be done in this spatial region, as all the cache lines of the region were represented by training demands going down the spatial prefetcher pipeline at the same time. In this situation, writing this spatial region to the output queue may be omitted.

In certain examples, prefetching circuitry may include L1 and/or L2 prefetch filters that aim to reduce the number of redundant prefetches that are sent to the L1 and/or L2 cache.

For example, an L2 prefetch filter may store a database of recent demand accesses and prefetches (e.g., organized by 4 KB pages). It may also supply data an AMPM prefetcher uses to generate prefetches and may help a stream prefetcher determine if it should operate in full-page mode.

In certain examples, a (e.g., L2) prefetch filter may include page trackers to track a number of (e.g., 4 KB) pages and to maintain for each a record of demand and prefetch accesses in that page. The page trackers may also keep track of the CEIP of the first demand to the page, the number of unique demand accesses to the page, and have the ability to determine the stream direction through the page. True LRU may be used for replacement of page tracker entries.

As one example, each page tracker may be 197 bits, with the page trackers organized in a banked, set-associative structure (e.g., four banks, eight sets each, and four ways). In total, 128 page tracker entries may be implemented with 3152 bytes of storage. Each bank may have one read port and one write port.

In certain examples, if a training demand wants to read a tracker entry in a cycle in which the bank is busy, the prefetch filter instead delivers dummy vectors full of 0s for the demand and prefetch maps. Similarly, to write more than one page tracker per bank in a cycle, a write or writes may be omitted. Therefore, a page tracker may not perfectly reflect the history of demands and prefetches in the page.

In certain examples, a (e.g., L2) prefetch filter's page tracker entry may include one or more of the fields shown in Table 29.

TABLE 29
Example L2 Prefetch Filter's Page Tracker Entry Fields

| Name | Size | Description |
|---|---|---|
| virt_page_addr | 36-bits | virtual address of the |
| | | page this entry tracks |
| CEIP | 16-bits | the instruction that first |
| | | demand-accessed this page |
| demand_map | 64-bits | bit map for all demand |
| | | accessed cache lines |
| prefetch_map | 64-bits | bit map for all |
| | | prefetched cache lines |
| unique_demand_count | 6-bits | the number of unique cache |
| | | lines in this page that have |
| | | been demand accessed |
| last_offset | 6-bits | the last cache line in this |
| | | page that was accessed |
| direction_tracker | 3-bits | saturating counter indicating |
| | | the general direction of |
| | | accesses in this page |
| lru | 2-bits | true LRU used for replacement |

In certain examples, a (e.g., L2) prefetch filter may include an array of CEIP trackers, which may be used to determine which instructions typically first-touch a page that then goes on to be fully used (i.e., every cache line will be brought into the cache). Pages first-touched by these instructions can be efficiently prefetched in their entirety.

For example, each CEIP tracker may store a CEIP, which acts as its tag, and has a confidence, direction, and replacement information. One CEIP tracker may be allocated per cycle.

In certain examples, a (e.g., L2) prefetch filter's CEIP tracker entry may include one or more of the fields shown in Table 30.

TABLE 30
Example L2 Prefetch Filter's CEIP Tracker Entry Fields

| Name | Size | Description |
|---|---|---|
| CEIP | 16-bits | the instruction that first |
| | | demand-accessed this page |
| confidence | 3-bits | confidence that this entry |
| | | corresponds to a full-use CEIP |
| direction | 4-bits | if this entry corresponds to a |
| | | full-use CEIP, the direction to be |
| | | prefetched through the page |
| lru | 3-bits | true LRU used for replacement |

In certain examples, a (e.g., L2) prefetch filter may have four jobs. The first may be to record a history of recent L2 demands and prefetches. The second may be to filter out redundant prefetches. The third may be to supply demand and prefetch maps as input to an L2 AMPM prefetcher. The fourth may be to identify CEIPs of instructions that are likely to first-touch a page where all cache lines will eventually be used.

These jobs may be broken up into two pipeline types. The first may be for demand training packets that are sent to the prefetcher circuitry from the L2 slices. The second may be for prefetches generated by the L2 prefetchers. There may be a number (e.g., four) of each of these pipes, corresponding to the number (e.g., four) of L2 cache slices.

Therefore, a (e.g., L2) prefetch filter may have two sets of pipelines (e.g., L2 filter demand pipeline(s) and L2 filter prefetch pipeline(s), each as described below) working together to determine what page tracker entries should be read from and what should be written back into the page tracker structure.

In certain examples, an (e.g., L2) filter demand pipeline may be broken up into seven stages. Prefetch training packets from the L2 may be sent down this pipeline, and the L2 prefetchers may branch off from it (as described below for the 12pfd02, 12pfd04, and 12pfd05 stages. A (e.g., L2) filter demand pipeline may be implemented, for example, as shown in Table 31 and described below.

TABLE 31
Example L2 Filter Demand Pipeline

| 12pfd01 | 12pfd02 | 12pfd03 | 12pfd04 | 12pfd05 | 12pfd06 | 12pfd07 |
|---|---|---|---|---|---|---|
| dispatch | gen_vpage | search_trackers | read_tracker | cross_pipe_writes | set_demands | writeback_trackers |
| | gen_offset | | alloc_tracker | | update_demand_counts | |
| | | | | | update_dirs | |
| | | | | | update_tracker_ceip | |
| | gen_adj_vpages | search_adj_trackers | read_adj_trackers | <to train | | |
| | | | | ampm> | | |
| | cross_pipe_reads | | | | | |
| | search_ceip_trackers | update_ceip_trackers | | | update_ceip_dir | |
| | | allocate_ceip_tracker | | | | |
| | <to train | read_full_page_pre- | <to train | | | |
| | spatial> | dictions | stream> | | | |

In the 12pfd01 stage, a dispatch operation may be performed. Prefetch training packets may arrive at the prefetcher circuitry from each L2 slice, and a dispatch operation, for example, may include inserted a prefetch training packet into the corresponding L2 filter demand pipeline.

In the 12pfd02 stage, a gen_vpage operation, a gen_offset operation, a gen_adj_vpages operation, a cross_pipe_reads operation, and/or a search_ceip_trackers operation may be performed. A gen_vpage operation, for example, may include selecting bits (e.g., 47:12) from the training virtual address as the virtual page number. A gen_offset operation, for example, may include selecting bits (e.g., 11:6) from the training virtual address as the offset within the page. A gen_adj_vpages operation, for example, may include generating virtual page numbers for the adjacent (+1 & −1) virtual (e.g., 4 KB) pages. Each pipeline would like to read three page trackers for each training demand, which might work in situations in which all of the pipelines are working on training demands in the same (e.g., 4 KB) page. If not, then a cross_pipe_reads operation, for example, may include determining which pages may be read, and which pages for which to skip reading. This stage communicates between the (e.g., four) L2 filter demand pipelines and the (e.g., four) L2 filter prefetch pipelines to determine the set of (e.g., 4 KB) pages to search for in the page tracker. The (e.g., 4 KB) pages that the most pipes are interested in are the winners, using round robin among the pipelines to break ties, while also respecting the one page per bank limit. A search_ceip_trackers operation, for example, may include using the training demand's CEIP to perform an associative search of the CEIP trackers.

In the 12pfd03 stage, a search trackers operation, a search_adj_trackers operation, an update_ceip_trackers operation, an allocate_ceip_tracker operation, and/or a read_full_page_predictions operation may be performed. A search trackers operation, for example, may include the (e.g., four) pipelines collectively searching the page trackers for the (e.g., up to 4×4 KB) pages that it was determined in the 12pfd02 should be used (e.g., maximum of one per bank). A search_adj_trackers operation, for example, may include the (e.g., four) pipelines collectively searching the adjacent page trackers for the (e.g., up to 4×4 KB) pages that it was determined in the 12pfd02 should be used (e.g., maximum of one per bank). If it is determined that there is a miss in searching the page trackers for the demand (non-adjacent) page of this training demand, then an update_ceip_trackers operation, for example, may include decreasing the confidence in this CEIP being a full-page CEIP. If there was a CEIP tracker miss, an allocate_ceip_tracker operation, for example, may include allocating a new entry, round robining on pipelines to resolve conflicts with other pipelines that also want to allocate a CEIP tracker this cycle. If there was a CEIP tracker hit, a read_full_page_predictions operation, for example, may include reading out the full page prediction (e.g., confidence and direction).

In the 12pfd04 stage, a read_tracker operation, a read_adj_trackers operation, and/or an alloc_tracker operation may be performed. A read_tracker operation, for example, may include, for all page tracker hits from the previous stage, reading out the page tracker information to pass to the subsequent pipeline stages, and for all pages that were a miss, instead of the real data from a real tracker entry, instead send demand and prefetch maps full of 0s. A read_adj_trackers operation, for example, may include for all page tracker hits from the previous stage, reading out the adjacent page tracker information to pass to the subsequent pipeline stages, and for all pages that were a miss, instead of the real data from a real tracker entry, instead send demand and prefetch maps full of 0s. An alloc_tracker operation, for example, may include allocating a new page tracker if needed, round robining among the pipelines if more than one wants to allocate on the same cycle, and, since page trackers may be in a (e.g., four-way) set associative structure with true LRU, finding the LRU or invalid page tracker to replace next. New page trackers may be allocated with the current virtual page, the CEIP (if known at this time), and the demand page offset (again, if known at this time). Everything else may be zeroed out. With the full_page_prediction in hand from p2pfd03, this stage may also include sending the L2 demand training packet down the stream prefetcher pipeline. This stage may correspond to the dispatch stage of the stream prefetcher pipeline.

In the 12pfd05 stage, a cross_pipe writes operation may be performed. For example, a cross_pipe writes operation may include determining, through cross-pipe communication, which bits in the demand map are to be written, determining by how much the unique demand counter is to be increased, determining how the direction saturating counter is to change, using a round robin scheme to determine which training demand will be recorded as this page tracker's last offset if there were more than one pipeline with a demand to this page tracker at this time, and if the page tracker does not have a CEIP set, determining if the CEIP of a demand access may be added to this page tracker entry. Only one pipeline is to be chosen to ultimately write back the page tracker entry to the page tracker structure. Similarly, the L2 filter prefetch pipelines may determine what prefetches to mark. This stage may also include sending, to the AMPM prefetcher, the training demand packet along with the demand and prefetch maps read out in the previous stage (or the dummy bitmaps of 0s) for the current page and its two adjacent pages.

In the 12pfd06 stage, a set_demands operation, an update_demand_counts operation, an update_dirs operation, an update_tracker_ceip operation, and/or an update_ceip_dir operation may be performed. A set_demands operation, for example, may include recording, by the one pipeline that will ultimately be writing back the page tracker entry to the page tracker structure, the set of demands in the page tracker's demand map. An update_demand_counts operation, for example, may include recording, by the one pipeline that will ultimately be writing back the page tracker entry to the page tracker structure, the demand counts in the page tracker. An update_dirs operation, for example, may include recording, by the one pipeline that will ultimately be writing back the page tracker entry to the page tracker structure, the direction in the page tracker. An update_tracker_ceip operation, for example, may include recording, by the one pipeline that will ultimately be writing back the page tracker entry to the page tracker structure, the CEIP in the page tracker. If the number of unique demands crosses a fixed or configurable threshold at this time, an update_ceip_dir operation, for example, may include, updating the CEIP tracker entry for this tracker's CEIP to have greater confidence and move its direction saturating counter in the direction that the stream is moving through this page.

In the 12pfd07 stage, a writeback trackers operation may be performed. For example, a writeback trackers may include, for page tracker entries in the pipeline that had any updates to them, including updates to their demand or prefetch maps, or any of their other metadata, writing back to the same spot in the page tracker structure where they were found, OR-ing in the demand and prefetch maps with what was already there, and updating the LRU information.

In certain examples, an (e.g., L2) filter prefetch pipeline may be broken up into seven stages. Prefetches chosen by the prefetch parcel out of the individual L2 prefetchers' output queues may be sent down these pipelines before being sent to the L2 slices. A (e.g., L2) filter prefetch pipeline may be implemented, for example, as shown in Table 32 and described below.

TABLE 32
Example L2 Filter Prefetch Pipeline

| 12pfp01 | 12pfp02 | 12pfp03 | 12pfp04 | 12pfp05 | 12pfp06 | 12pfp07 |
|---|---|---|---|---|---|---|
| dispatch | gen_vpage | search_trackers | read_tracker | cross_pipe_writes | set_prefetch_bits | writeback_tracker |
| | gen_offset | generate_prefetch_vector | alloc_tracker | | | |
| | cross_pipe_reads | | | | | |

In the 12pdp01 stage, a dispatch operation may be performed. For example, prefetches selected by the prefetch circuitry from the individual L2 prefetcher output queues may be inserted into the L2 filter prefetch pipeline corresponding the L2 slice where they are headed.

In the 12pdp02 stage, a gen_vpage operation, a gen_offset operation, and/or a cross_pipe_reads may be performed. A gen_vpage operation, for example, may include selecting the virtual page bits, as in the L2 filter demand pipeline. A gen_offset operation, for example, may include determining the page offset of the prefetch (e.g., bits 11:6 of the byte address of the prefetch). A cross_pipe_reads operation, for example, may include communicating between L2 filter prefetch pipelines and L2 filter demand pipelines to determine the set of page tracker entries that should be read from the page tracker structure (as described for an 12pfd02 stage). The L2 filter prefetch pipelines may also communicate to determine the set of prefetches to be marked in each page.

In the 12pdp03 stage, a search trackers operation and/or a generate_prefetch vector may be performed. A search trackers operation, for example, may be as described above for an 12pfd03 stage. A generate_prefetch vector operation, for example, may include generating a bitmap of prefetches going to the current page, which may be OR′d into the page tracker's prefetch map.

In the 12pdp04 stage, a read_tracker operation and/or an alloc_tracker may be performed. A read_tracker operation, for example, may be as described above for an 12pfd04 stage. An alloc_tracker operation, for example, may be as described above for an 12pfd04 stage.

In the 12pdp05 stage, a cross_pipe writes operation may be performed. For example, a cross_pipe writes operation may include the L2 filter prefetch pipes communicating to the L2 filter demand pipes that will be writing back the page tracker entry the prefetch vector generated in an 12pfp03 stage.

In the 12pdp06 stage, a set_prefetch bits operation may be performed. For example, a set_prefetch bits operation may include the L2 filter demand pipe responsible for writing back the page tracker entry OR-ing in the prefetch vector to the existing prefetch map.

In the 12pdp07 stage, a writeback tracker operation may be performed. For example, a writeback tracker operation may include the L2 filter demand pipe responsible for writing back the page tracker entry writing back the entry, as described above for an 12pfd07 stage.

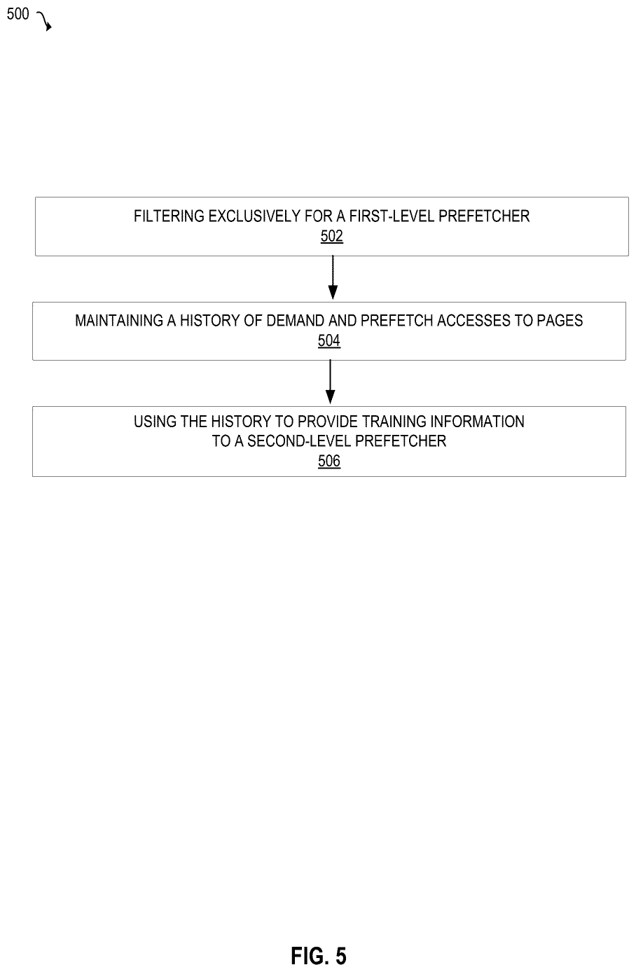

FIG. 5 is a flow diagram illustrating operations 500 of a method for prefetching by a hardware processor according to examples of the disclosure. Some or all of the operations 500 (or other processes described herein, or variations, and/or combinations thereof) are configured under the control of a core (or other components discussed herein) as implemented herein and/or one or more computer systems (e.g., processors) configured with executable instructions and are implemented as code (e.g., executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory. In some examples, one or more (or all) of the operations 500 are performed by memory circuitry (e.g., memory circuitry 104) of the other figures.

The operations 500 include, at block 502, filtering, by a first prefetch filter, exclusively for a first prefetcher of a plurality of prefetchers, wherein the first prefetcher is to prefetch data from a system memory to a first cache memory at a first cache level of a plurality of cache levels.

The first prefetcher may be a next line prefetcher. The first prefetch filter may be a bloom filter to filter out redundant prefetch requests generated by the next line prefetcher. The first prefetcher may be an instruction pointer prefetcher. The first prefetch filter may filter for the instruction pointer prefetcher based on stride magnitude.

The operations 500 include, at block 504, maintaining, by a second prefetch filter, a history of demand and prefetch accesses to pages in the system memory.

The operations 500 include, at block 506, using, by the second prefetch filter, the history to provide training information to a second prefetcher of the plurality of prefetchers, wherein the second prefetcher is to prefetch data from the system memory to a second cache memory at a second cache level of the plurality of cache levels.

The second prefetcher may be an access map pattern matching prefetcher. The second prefetch filter may provide maps to the access map pattern matching prefetcher. The second prefetcher may be a stream prefetcher. The second prefetch filter may provide information to the stream prefetcher to determine whether to operate in a full-page mode.

Example architectures, systems, etc. that the above may be used in are detailed below.

At least some examples of the disclosed technologies can be described in view of the following examples.
Example 1. An apparatus comprising:
execution circuitry to execute one or more instructions to access data at a memory address;
a plurality of cache memories, the plurality of cache memories including at least a first cache memory at a first level of a plurality of cache levels and at least a second cache memory at a second level of the plurality of cache levels; and
prefetcher circuitry, coupled to the execution circuit, the prefetcher circuitry to prefetch the data from a system memory to at least one of the plurality of cache memories, the prefetcher circuitry including:
   a first-level prefetcher to prefetch the data to the first cache memory;
   a second-level prefetcher to prefetch the data to the second cache memory; and
   a plurality of prefetch filters, wherein at least a first prefetch filter of the plurality of prefetch filters is to filter exclusively for the first-level prefetcher and at least a second prefetch filter of the plurality of prefetch filters is to maintain a history of demand and prefetch accesses to pages in the system memory and to use the history to provide training information to the second-level prefetcher.
Example 2. The apparatus of example 1, wherein the first-level prefetcher is a next line prefetcher.
Example 3. The apparatus of example 2, wherein the first prefetch filter is a bloom filter to filter out redundant prefetch requests generated by the next line prefetcher.
Example 4. The apparatus of example 1, wherein the first-level prefetcher is an instruction pointer prefetcher.
Example 5. The apparatus of example 4, wherein the first prefetch filter is to filter for the instruction pointer prefetcher based on stride magnitude.
Example 6. The apparatus of example 1, wherein the second-level prefetcher is an access map pattern matching prefetcher.
Example 7. The apparatus of example 6, wherein the second prefetch filter is to provide maps to the access map pattern matching prefetcher.
Example 8. The apparatus of example 1, wherein the second-level prefetcher is a stream prefetcher.
Example 9. The apparatus of example 8, wherein the second prefetch filter is to provide information to the stream prefetcher to determine whether to operate in a full-page mode.
Example 10. A method comprising:
filtering, by a first prefetch filter, exclusively for a first prefetcher of a plurality of prefetchers, wherein the first prefetcher is to prefetch data from a system memory to a first cache memory at a first cache level of a plurality of cache levels;
maintaining, by a second prefetch filter, a history of demand and prefetch accesses to pages in the system memory; and
using, by the second prefetch filter, the history to provide training information to a second prefetcher of the plurality of prefetchers, wherein the second prefetcher is to prefetch data from the system memory to a second cache memory at a second cache level of the plurality of cache levels.
Example 11. The method of example 10, wherein the first prefetcher is a next line prefetcher.
Example 12. The method of example 11, wherein the first prefetch filter is a bloom filter to filter out redundant prefetch requests generated by the next line prefetcher.
Example 13. The method of example 10, wherein the first prefetcher is an instruction pointer prefetcher.
Example 14. The method of example 13, wherein the first prefetch filter is to filter for the instruction pointer prefetcher based on stride magnitude.
Example 15. The method of example 10, wherein the second prefetcher is an access map
Example 16. The method of example 15, wherein the second prefetch filter is to provide maps to the access map pattern matching prefetcher.
Example 17. The method of example 10, wherein the second prefetcher is a stream prefetcher.
Example 18. The method of example 17, wherein the second prefetch filter is to provide information to the stream prefetcher to determine whether to operate in a full-page mode.
Example 19. A system comprising:
a memory controller to access a system memory; and
a hardware processor coupled to the memory controller, the hardware processor comprising:
   execution circuitry to execute one or more instructions to access data at a memory address;
   a plurality of cache memories, the plurality of cache memories including at least a first cache memory at a first level of a plurality of cache levels and at least a second cache memory at a second level of the plurality of cache levels; and
   prefetcher circuitry, coupled to the execution circuit, the prefetcher circuitry to prefetch the data from the system memory to at least one of the plurality of cache memories, the prefetcher circuitry including:
      a first-level prefetcher to prefetch the data to the first cache memory;
      a second-level prefetcher to prefetch the data to the second cache memory; and
      a plurality of prefetch filters, wherein at least a first prefetch filter of the plurality of prefetch filters is to filter exclusively for the first-level prefetcher and at least a second prefetch filter of the plurality of prefetch filters is to maintain a history of demand and prefetch accesses to pages in the system memory and to use the history to provide training information to the second-level prefetcher.
Example 20. The system of example 19, further comprising the system memory.

### Example Computer Architectures

Detailed below are descriptions of example computer architectures. Other system designs and configurations known in the arts for laptop, desktop, and handheld personal computers, (PC)s, personal digital assistants, engineering workstations, servers, disaggregated servers, network devices, network hubs, switches, routers, embedded processors, digital signal processors (DSPs), graphics devices, video game devices, set-top circuitry, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 6 illustrates an example computing system. Multiprocessor system 600 is an interfaced system and includes a plurality of processors or cores including a first processor 670 and a second processor 680 coupled via an interface 650 such as a point-to-point (P-P) interconnect, a fabric, and/or bus. In some examples, the first processor 670 and the second processor 680 are homogeneous. In some examples, first processor 670 and the second processor 680 are heterogenous. Though the example system 600 is shown to have two processors, the system may have three or more processors, or may be a single processor system. In some examples, the computing system is a system on a chip (SoC).

Processors 670 and 680 are shown including integrated memory controller (IMC) circuitry 672 and 682, respectively. Processor 670 also includes interface circuits 676 and 678; similarly, second processor 680 includes interface circuits 686 and 688. Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW I/F) 690 via individual interfaces 652, 654 using interface circuits 676, 694, 686, 698. The network interface 690 (e.g., one or more of an interconnect, bus, and/or fabric, and in some examples is a chipset) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, first interface 616 may be an interface such as a Peripheral Component Interconnect (PCI) interconnect, a PCI Express interconnect or another I/O interconnect. In some examples, first interface 616 is coupled to a power control unit (PCU) 617, which may include circuitry, software, and/or firmware to perform power management operations with regard to the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, second interface 620 may be a low pin count (LPC) interface. Various devices may be coupled to second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement the storage 628 in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

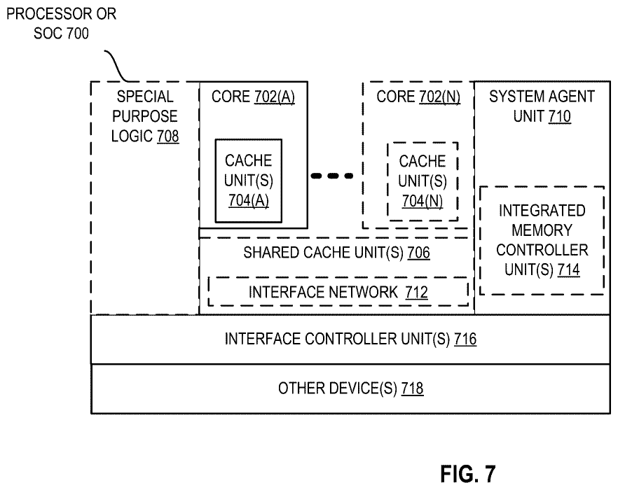

FIG. 7 illustrates a block diagram of an example processor and/or SoC 700 that may have one or more cores and an integrated memory controller. The solid lined circuitry illustrate a processor 700 with a single core 702(A), system agent unit circuitry 710, and a set of one or more interface controller unit(s) circuitry 716, while the optional addition of the dashed lined circuitry illustrates an alternative processor 700 with multiple cores 702(A)-(N), a set of one or more integrated memory controller unit(s) circuitry 714 in the system agent unit circuitry 710, and special purpose logic 708, as well as a set of one or more interface controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702(A)-(N) being one or more general purpose cores (e.g., general purpose in-order cores, general purpose out-of-order cores, or a combination of the two); 2) a coprocessor with the cores 702(A)-(N) being a large number of special purpose cores intended primarily for graphics and/or scientific (throughput); and 3) a coprocessor with the cores 702(A)-(N) being a large number of general purpose in-order cores. Thus, the processor 700 may be a general-purpose processor, coprocessor, or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller units circuitry 716 couple the cores 702 to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

Example Core Architectures—In-order and Out-of-order Core Block Diagram

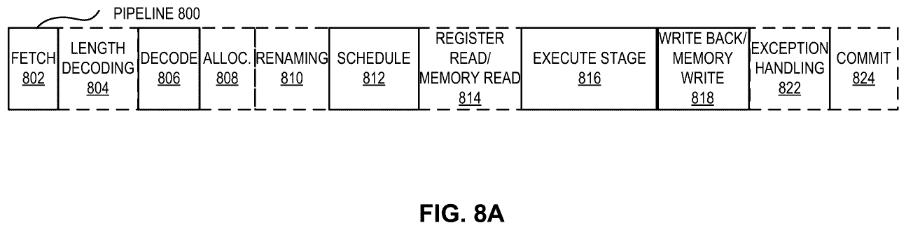

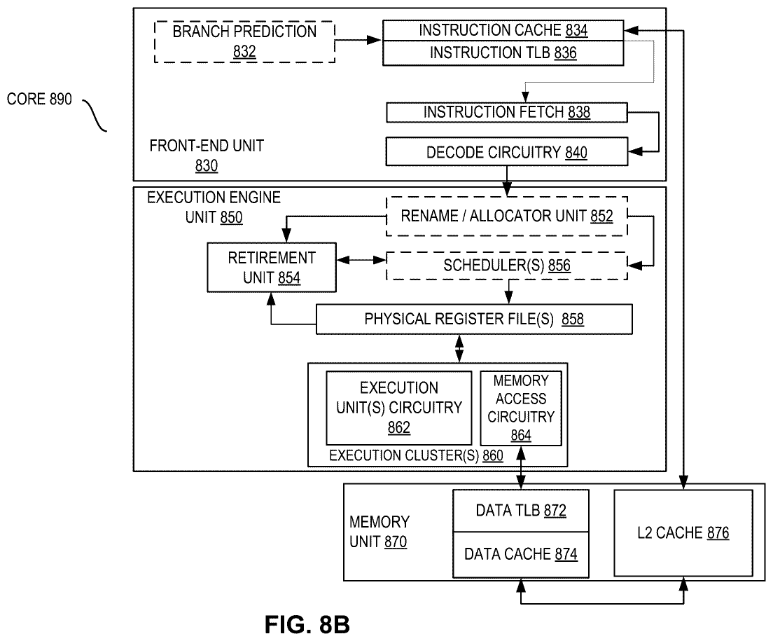

FIG. 8A is a block diagram illustrating both an example in-order pipeline and an example register renaming, out-of-order issue/execution pipeline according to examples. FIG. 8B is a block diagram illustrating both an example in-order architecture core and an example register renaming, out-of-order issue/execution architecture core to be included in a processor according to examples. The solid lined circuitry in FIGS. 8A-(B) illustrate the in-order pipeline and in-order core, while the optional addition of the dashed lined circuitry illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 8B may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8B shows a processor core 890 including front-end unit circuitry 830 coupled to execution engine unit circuitry 850, and both are coupled to memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front-end unit circuitry 830 may include branch prediction circuitry 832 coupled to instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various different mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front-end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, address generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to data cache circuitry 874 coupled to level 2 (L2) cache circuitry 876. In one example, the memory access circuitry 864 may include load unit circuitry, store address unit circuitry, and store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Example Execution Unit(s) Circuitry

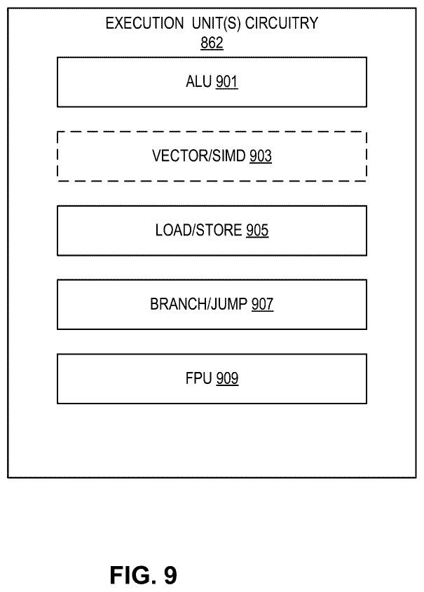

FIG. 9 illustrates examples of execution unit(s) circuitry, such as execution unit(s) circuitry 862 of FIG. 8B. As illustrated, execution unit(s) circuitry 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.)

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

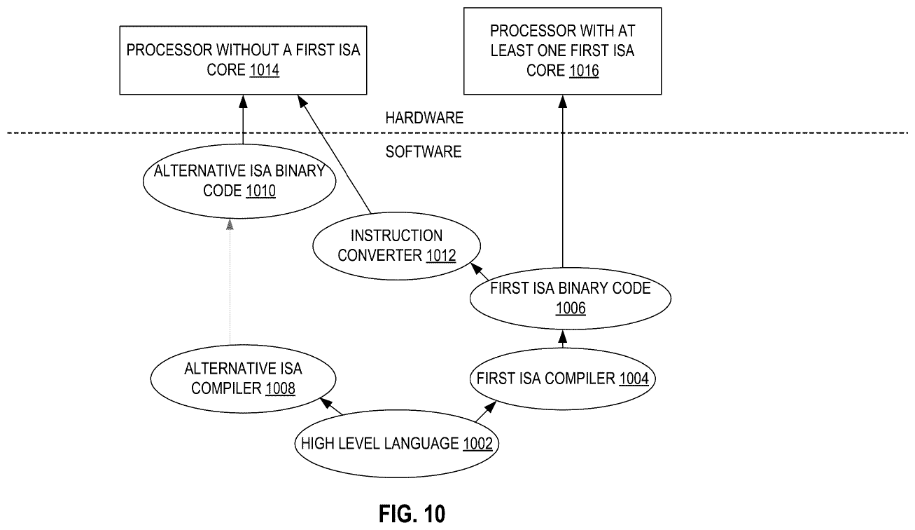

FIG. 10 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 10 shows a program in a high-level language 1002 may be compiled using a first ISA compiler 1004 to generate first ISA binary code 1006 that may be natively executed by a processor with at least one first ISA core 1016. The processor with at least one first ISA core 1016 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1004 represents a compiler that is operable to generate first ISA binary code 1006 (e.g., object code) that can, with or without additional linkage processing, be executed on the processor with at least one first ISA core 1016. Similarly, FIG. 10 shows the program in the high-level language 1002 may be compiled using an alternative ISA compiler 1008 to generate alternative ISA binary code 1010 that may be natively executed by a processor without a first ISA core 1014. The instruction converter 1012 is used to convert the first ISA binary code 1006 into code that may be natively executed by the processor without a first ISA core 1014. This converted code is not necessarily to be the same as the alternative ISA binary code 1010; however, the converted code will accomplish the general operation and be made up of instructions from the alternative ISA. Thus, the instruction converter 1012 represents software, firmware, hardware, or a combination thereof that, through emulation, simulation, or any other process, allows a processor or other electronic device that does not have a first ISA processor or core to execute the first ISA binary code 1006.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
execution circuitry to execute one or more instructions to access data at a memory address;
a plurality of cache memories, the plurality of cache memories including at least a first cache memory at a first level of a plurality of cache levels and at least a second cache memory at a second level of the plurality of cache levels; and
prefetcher circuitry, coupled to the execution circuit, the prefetcher circuitry to prefetch the data from a system memory to at least one of the plurality of cache memories, the prefetcher circuitry including:
a first-level prefetcher to prefetch the data to the first cache memory;
a second-level prefetcher to prefetch the data to the second cache memory; and
a plurality of prefetch filters, wherein at least a first prefetch filter of the plurality of prefetch filters is to filter exclusively for the first-level prefetcher and at least a second prefetch filter of the plurality of prefetch filters is to maintain a history of demand and prefetch accesses to pages in the system memory and to use the history to provide training information to the second-level prefetcher.

2. The apparatus of claim 1, wherein the first-level prefetcher is a next line prefetcher.

3. The apparatus of claim 2, wherein the first prefetch filter is a bloom filter to filter out redundant prefetch requests generated by the next line prefetcher.

4. The apparatus of claim 1, wherein the first-level prefetcher is an instruction pointer prefetcher.

5. The apparatus of claim 4, wherein the first prefetch filter is to filter for the instruction pointer prefetcher based on stride magnitude.

6. The apparatus of claim 1, wherein the second-level prefetcher is an access map pattern matching prefetcher.

7. The apparatus of claim 6, wherein the second prefetch filter is to provide maps to the access map pattern matching prefetcher.

8. The apparatus of claim 1, wherein the second-level prefetcher is a stream prefetcher.

9. The apparatus of claim 8, wherein the second prefetch filter is to provide information to the stream prefetcher to determine whether to operate in a full-page mode.

10. A method comprising:
filtering, by a first prefetch filter, exclusively for a first prefetcher of a plurality of prefetchers, wherein the first prefetcher is to prefetch data from a system memory to a first cache memory at a first cache level of a plurality of cache levels;
maintaining, by a second prefetch filter, a history of demand and prefetch accesses to pages in the system memory; and
using, by the second prefetch filter, the history to provide training information to a second prefetcher of the plurality of prefetchers, wherein the second prefetcher is to prefetch data from the system memory to a second cache memory at a second cache level of the plurality of cache levels.

11. The method of claim 10, wherein the first prefetcher is a next line prefetcher.

12. The method of claim 11, wherein the first prefetch filter is a bloom filter to filter out redundant prefetch requests generated by the next line prefetcher.

13. The method of claim 10, wherein the first prefetcher is an instruction pointer prefetcher.

14. The method of claim 13, wherein the first prefetch filter is to filter for the instruction pointer prefetcher based on stride magnitude.

15. The method of claim 10, wherein the second prefetcher is an access map pattern matching prefetcher.

16. The method of claim 15, wherein the second prefetch filter is to provide maps to the access map pattern matching prefetcher.

17. The method of claim 10, wherein the second prefetcher is a stream prefetcher.

18. The method of claim 17, wherein the second prefetch filter is to provide information to the stream prefetcher to determine whether to operate in a full-page mode.

19. A system comprising:
a memory controller to access a system memory; and
a hardware processor coupled to the memory controller, the hardware processor comprising:
execution circuitry to execute one or more instructions to access data at a memory address;
a plurality of cache memories, the plurality of cache memories including at least a first cache memory at a first level of a plurality of cache levels and at least a second cache memory at a second level of the plurality of cache levels; and
prefetcher circuitry, coupled to the execution circuit, the prefetcher circuitry to prefetch the data from the system memory to at least one of the plurality of cache memories, the prefetcher circuitry including:
a first-level prefetcher to prefetch the data to the first cache memory;
a second-level prefetcher to prefetch the data to the second cache memory; and
a plurality of prefetch filters, wherein at least a first prefetch filter of the plurality of prefetch filters is to filter exclusively for the first-level prefetcher and at least a second prefetch filter of the plurality of prefetch filters is to maintain a history of demand and prefetch accesses to pages in the system memory and to use the history to provide training information to the second-level prefetcher.

20. The system of claim 19, further comprising the system memory.
